(19) United States
(12) Patent Application Publication
(10) Pub. No.: US 2026/0307718 A1
(43) Pub. Date: Oct. 8, 2026

(54) POSITION SENSING WITH HETEROGENEOUS REDUNDANCY

(71) Applicant: HL MANDO CORPORATION, Gyeonggi-do (KR)

(72) Inventors: Christian ROSS, Auburn, MI (US); Mohammad ISLAM, Auburn, MI (US); Jeremy BREAULT, Auburn, MI (US); Arthur LICHT, Auburn, MI (US); Md Sariful ISLAM, Auburn, MI (US)

(21) Appl. No.: 19/636,817

(22) Filed: Apr. 1, 2026

Related U.S. Application Data
(60) Provisional application No. 63/782,508, filed on Apr. 2, 2025.
(60) Provisional application No. 63/785,523, filed on Apr. 8, 2025.

(51) Int. Cl. B62D 15/02; B62D 5/04

(52) U.S. Cl. CPC B62D 15/022; B62D 5/0406; B62D 5/0409

(57) ABSTRACT

A motor system may comprise: an inductive-sensing target and a magnet which are mounted to a motor shaft; a circuit board; a magnetic sensor configured to sense magnetic field associated with the magnet mounted to the motor shaft; and an inductive sensor configured to sense electromagnetic induction associated with the inductive-sensing target mounted to the motor shaft. The magnetic sensor and the inductive sensor may be mounted to the circuit board.

### CROSS REFERENCE TO RELATED PATENT APPLICATION(S)

This application claims the benefit of U.S. Patent Application Ser. No. 63/782,508 filed on Apr. 2, 2025, entitled “STEER-BY-WIRE SYSTEM INCLUDING STEERING FEEDBACK ACTUATOR (SFA) AND ROAD WHEEL ACTUATOR (RWA)” and U.S. Patent Application Ser. No. 63/785,523 filed on Apr. 8, 2025, entitled “MECHANICAL INTEGRATION WITH POSITION SENSING”, which are all hereby incorporated by reference in their entireties.

### BACKGROUND

Various embodiments of the present disclosure generally relate to a steering system for a vehicle and more particularly to a steer-by-wire system.

Vehicles require a steering system to control the direction of travel. Previously, mechanical steering systems have been used. The mechanical steering systems typically include a mechanical linkage or a mechanical connection between a steering wheel and vehicle's road wheels. For example, in a conventional steering system, which consists of a steering wheel, a steering column, a power assisted rack and pinion system, and tie rods, the driver turns the steering wheel which, through the various mechanical components, causes the road wheels of the vehicle to turn. Thus, movement of the steering wheel causes a corresponding movement of the road wheels. Movement of such mechanical systems is often power assisted through the use of hydraulic assists or electric motors.

The mechanical steering systems are expected to be replaced or supplemented by electrically driven steering systems, commonly known as “steer-by-wire” systems. Such steer-by-wire systems to varying extents replace, for example, the mechanical linkage between the steering wheel and the road wheels with one or more sensors, actuators and electronics. The steer-by-wire system aims to eliminate physical or mechanical connection between the steering wheel and vehicle wheels, and to change the direction of the vehicle wheels and provide feedback to a driver by using electrically controlled motors. Even though the mechanical linkage between the steering wheel and the road wheels has been eliminated, the steer-by-wire system is expected not only to produce the same functions and steering feel as a conventional mechanically linked steering system, but it is also expected to implement advanced steering system features. Requirements for conventional steering functions and advanced steering features such as adjustable steering feel can be implemented by an advanced control system design.

It is with respect to these and other general considerations that the following embodiments have been described. Also, although relatively specific problems have been discussed, it should be understood that the embodiments should not be limited to solving the specific problems identified in the background.

### SUMMARY

The features and advantages of the present disclosure will be more readily understood and apparent from the following detailed description, which should be read in conjunction with the accompanying drawings, and from the claims which are appended to the end of the detailed description.

According to an embodiment of the present disclosure, a motor system may comprise: an inductive-sensing target and a magnet which are mounted to a motor shaft; a circuit board; a magnetic sensor configured to sense magnetic field associated with the magnet mounted to the motor shaft; and an inductive sensor configured to sense electromagnetic induction associated with the inductive-sensing target mounted to the motor shaft, wherein the magnetic sensor and the inductive sensor are mounted to the circuit board.

The magnetic sensor and the inductive sensor may be mounted to a surface of the circuit board facing an end of the motor shaft to which the inductive-sensing target and the magnet are mounted.

The motor system may further comprise a magnet holder coupling the magnet to the motor shaft.

The magnet mounted to the motor shaft may be disposed within an inner space of the magnet holder.

The magnet holder may have non-magnetic material.

The motor system may further comprise a controller configured to determine a position of the motor shaft based on at least one of the magnetic field associated with the magnet mounted to the motor shaft or the electromagnetic induction associated with the inductive-sensing target mounted to the motor shaft.

The inductive sensor may be positioned offset from an axis of the motor shaft, and the magnetic sensor may be disposed on the axis of the motor shaft.

The motor system may further comprise an auxiliary rotor rotatably engaged with the motor shaft.

Each of the motor shaft and the auxiliary rotor may comprise a gear, the gear of the motor shaft and the gear of the auxiliary rotor may be rotatably engaged with one another, and a number of teeth of the gear of the motor shaft may be different from a number of the gear of the auxiliary rotor.

An other magnet may be mounted to the auxiliary rotor, and the motor system may further comprise an other magnetic sensor configured to sense magnetic field associated with the other magnet mounted to the auxiliary rotor.

The auxiliary rotor may include an other inductive-sensing target, and the motor system may further comprise an other inductive sensor configured to sense electromagnetic induction associated with the other inductive-sensing target included in the auxiliary rotor.

The motor shaft may be connected to a steering column connected to a steering wheel.

One end portion of the motor shaft may be connected to a steering column connected to a steering wheel, and the inductive-sensing target and the magnet may be mounted to an other end portion of the motor shaft.

The motor system may further comprise: an auxiliary rotor rotatably engaged with the motor shaft, and having an other magnet; and an other magnetic sensor configured to sense magnetic field associated with the other magnet mounted to the auxiliary rotor, wherein: the motor shaft is connected to a steering column connected to a steering wheel, and the controller is configured to determine a position of the steering column or the steering wheel based on the magnetic field associated with the other magnet mounted to the auxiliary rotor and at least one of the magnetic field associated with the magnet mounted to the motor shaft or the electromagnetic induction associated with the inductive-sensing target mounted to the motor shaft.

The motor system may further comprise: an auxiliary rotor rotatably engaged with the shaft of the motor, and comprising an other inductive-sensing target; and an other inductive sensor configured to sense electromagnetic induction associated with the other inductive-sensing target comprised in the auxiliary rotor, wherein: the motor shaft is connected to a steering column connected to a steering wheel, and the controller is configured to determine a position of the steering column or the steering wheel based on the electromagnetic induction associated with the other inductive-sensing target comprised in the auxiliary rotor and at least one of the magnetic field associated with the magnet mounted to the motor shaft or the electromagnetic induction associated with the inductive-sensing target mounted to the motor shaft.

The motor system may further comprise a stopper configured to limit a rotatable range of the motor shaft.

The inductive-sensing target may have a metallic pattern, and the inductive sensor may comprises a receiver including a sinusoidal coil and a cosinusoidal coil and a transmitter including at least one circular coil.

According to an embodiment of the present disclosure, a steer-by-wire system may comprise: a steering feedback actuator assembly connected to a steering wheel; and a roadwheel actuator assembly connected to road wheels, wherein the steering feedback actuator assembly includes a motor system comprising: a motor having a motor shaft connected to a steering column connected to the steering wheel; an inductive-sensing target and a magnet which are mounted to the motor shaft; a circuit board; a magnetic sensor configured to sense magnetic field associated with the magnet mounted to the motor shaft; and an inductive sensor configured to sense electromagnetic induction associated with the inductive-sensing target mounted to the motor shaft, wherein the magnetic sensor and the inductive sensor are mounted to the circuit board.

The magnetic sensor and the inductive sensor may be mounted to a surface of the circuit board facing an end of the motor shaft to which the inductive-sensing target and the magnet are mounted.

The steer-by-wire system may further comprise a magnet holder coupling the magnet to the motor shaft.

The magnet mounted to the motor shaft may be disposed within an inner space of the magnet holder.

The magnet holder may have non-magnetic material.

The steer-by-wire system may further comprise a controller configured to determine a position of the motor shaft based on at least one of the magnetic field associated with the magnet mounted to the motor shaft or the electromagnetic induction associated with the inductive-sensing target mounted to the motor shaft.

The inductive sensor may be positioned offset from an axis of the motor shaft, and the magnetic sensor may be disposed on the axis of the motor shaft.

The steer-by-wire system may further comprise an auxiliary rotor rotatably engaged with the motor shaft.

Each of the motor shaft and the auxiliary rotor may comprise a gear, the gear of the motor shaft and the gear of the auxiliary rotor are rotatably engaged with one another, and a number of teeth of the gear of the motor shaft may be different from a number of the gear of the auxiliary rotor.

One end portion of the motor shaft may be connected to the steering column connected to the steering wheel, and the inductive-sensing target and the magnet may be mounted to an other end portion of the motor shaft.

The steer-by-wire system may further comprise: an auxiliary rotor rotatably engaged with the motor shaft, and having an other magnet; and an other magnetic sensor configured to sense magnetic field associated with the other magnet mounted to the auxiliary rotor, wherein: the controller of the steering feedback actuator is configured to determine a position of the steering column or the steering wheel based on the magnetic field associated with the other magnet mounted to the auxiliary rotor and at least one of the magnetic field associated with the magnet mounted to the motor shaft or the electromagnetic induction associated with the inductive-sensing target mounted to the motor shaft, and transmit the position of the steering column or the steering wheel to an other controller included in the roadwheel actuator assembly; or the other magnetic sensor is configured to transmit, to the other controller included in the roadwheel actuator assembly, a signal related to the magnetic field associated with the other magnet mounted to the auxiliary rotor, and the magnetic sensor or the inductive sensor is configured to transmit a signal related to the magnetic field associated with the magnet mounted to the motor shaft or the electromagnetic induction associated with the inductive-sensing target mounted to the motor shaft.

The steer-by-wire system may further comprise: an auxiliary rotor rotatably engaged with the motor shaft, and comprising an other inductive-sensing target; and an other inductive sensor configured to sense electromagnetic induction associated with the other inductive-sensing target comprised in the auxiliary rotor, wherein: the controller of the steering feedback actuator is configured to determine a position of the steering column or the steering wheel based on the electromagnetic induction associated with the inductive-sensing target comprised in the auxiliary rotor and at least one of the magnetic field associated with the magnet mounted to the shaft of the motor or the electromagnetic induction associated with the inductive-sensing target mounted to the shaft of the motor, and transmit the position of the steering column or the steering wheel to an other controller included in the roadwheel actuator assembly; or the other inductive sensor is configured to transmit, to the other controller included in the roadwheel actuator assembly, a signal related to the electromagnetic induction associated with the other inductive-sensing target comprised in the auxiliary rotor, and the magnetic sensor or the inductive sensor is configured to transmit a signal related to the magnetic field associated with the magnet mounted to the motor shaft or the electromagnetic induction associated with the inductive-sensing target mounted to the motor shaft.

The inductive-sensing target may have a metallic pattern, and the inductive sensor may comprise a receiver including a sinusoidal coil and a cosinusoidal coil and a transmitter including at least one circular coil.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 is a schematic view schematically illustrating a steering apparatus according to an embodiment of the present disclosure;

FIGS. 2 to 7 are partial views illustrating a steering apparatus according to embodiments of the present disclosure;

FIG. 8 is a schematic view schematically illustrating a steering apparatus according to an embodiment of the present disclosure;

FIGS. 9 to 18 are partial views illustrating a steering apparatus according to an embodiment of the present disclosure;

FIG. 19 is a graph for explaining a method of estimating a rack bar position in accordance with a difference between first rotation information of a first motor and second rotation information of a second motor according to an embodiment of the present disclosure;

FIG. 20 is a schematic view of a vehicle including a steer-by-wire system according to an exemplary embodiment of the present disclosure;

FIG. 21 is a perspective view for showing a steer-by-wire system according to an exemplary embodiment of the present disclosure;

FIG. 22 is a cross-sectional view for illustrating a steer-by-wire system according to an exemplary embodiment of the present disclosure;

FIG. 23 is a partial cross-sectional view for illustrating a steer-by-wire system according to an exemplary embodiment of the present disclosure;

FIGS. 24-25 are a partial perspective view for illustrating a steer-by-wire system according to an exemplary embodiment of the present disclosure;

FIGS. 26-27 is partial cross-sectional views for illustrating a steer-by-wire system according to an exemplary embodiment of the present disclosure;

FIG. 28 is a partial plan view for illustrating a steer-by-wire system according to an exemplary embodiment of the present disclosure;

FIG. 29 is a partial perspective view for illustrating a steer-by-wire system according to an exemplary embodiment of the present disclosure;

FIG. 30 is a side view for illustrating a motor system according to an embodiment of the present disclosure;

FIG. 31 is a plan view for illustrating a motor system according to an embodiment of the present disclosure; and

FIG. 32 is a plan view for illustrating an inductive sensor according to an embodiment of the present disclosure.

FIG. 33 is a cross-sectional view for illustrating a motor system according to an embodiment of the present disclosure.

FIG. 34 is an exploded view for illustrating a motor system according to an embodiment of the present disclosure.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

A steering apparatus according to an embodiment of the present disclosure includes a ball nut 141, a first nut pulley 143a, a second nut pulley 143b, a first motor pulley 142a, a second motor pulley 142b, and an electronic control device 110. The ball nut 141 may be rotatably coupled to a rack bar 130 by means of balls 144 and may be configured to slide the rack bar 130 in an axial direction by the rotation of the ball nut 141. The first nut pulley 143a may be provided on an outer peripheral surface of the ball nut 141, and the second nut pulley 143b may be provided on the outer peripheral surface of the ball nut 141. The first motor pulley 142a may be coupled to a first motor 145 (e.g. fixed to a shaft of the first motor 145) or directly formed on a rotatable part of the first motor 145 and connected to a first nut pulley 143a through a first belt 149a. The second motor pulley 142b may be coupled to a second motor 147 (e.g. fixed to a shaft of the second motor 147) or directly formed on a rotatable part of the second motor 147 and connected to the second nut pulley 143b through a second belt 149a. The electronic control device 110 may include one or more controllers or processors and may be configured to control the first and second motors 145 and 147. For instance, the electronic control device 110 output one or more control signals to the first motor 145 and the second motor 147 in response to one or more electrical signals.

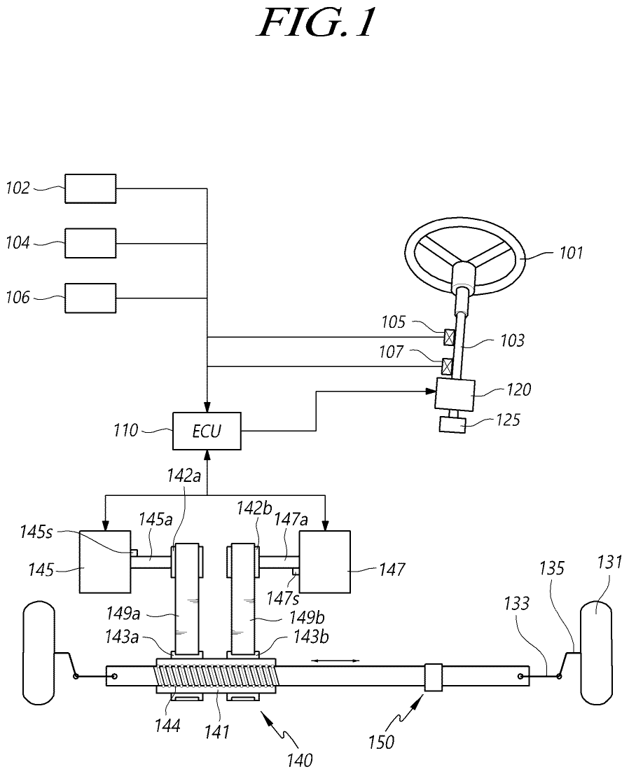

With reference to FIG. 1, in a steering apparatus according to the present disclosure, an angle sensor 105 and a torque sensor 107 may be coupled to one side of a steering shaft 103 connected to a steering wheel 101 or located around the steering shaft 103.

In an autonomous driving mode in which an autonomous driving system is driving the vehicle or in a driver assistance mode in which an driver assistance system such as an Advanced Driver Assistance System (ADAS) is assisting a driver with the operation of the vehicle, the electronic control device 110 controls a steering shaft motor 120, the first motor 145, and the second motor 147 by transmitting one or more control signals to the steering shaft motor 120, the first motor 145, and the second motor 147 in response to electrical signals transmitted from various sensors mounted in or to or associated with a vehicle.

In a driver driving mode, the electronic control device 110 controls the steering shaft motor 120, the first motor 145, and the second motor 147 by outputting one or more control signals to the steering shaft motor 120, the first motor 145, and the second motor 147 in response to electrical signals transmitted from the angle sensor 105, which detects a manipulation or rotation angle of the steering wheel 101 by the driver, electrical signals transmitted from the torque sensor 107, and electrical signals transmitted from various other sensors mounted in or to or associated with the vehicle.

In an embodiment illustrated in FIG. 1, the angle sensor 105 and the torque sensor 107 are provided as two separate and individual sensors. Alternatively, the angle sensor 105 and the torque sensor 107 may be integrated into one single sensor such as one torque angle sensor. The steering shaft motor 120 may be connected to or associated with a speed reducer configured to reduce a rotational speed of the steering shaft motor 120 including, for example, but not limited to, one or more gears, one or more pulleys, and/or one or more belts.

During normal driving, the steering shaft motor 120 provides appropriate steering feedback to the driver by providing a reaction force to the steering shaft 103 so that the driver may feel a steering reaction force against the driver's manipulation of the steering wheel 101. The steering shaft motor 120 may be also referred to as a reaction force motor. However, as described below, the steering shaft motor 120 may not only provide the reaction force but also operate in accordance with autonomous steering when the steering shaft motor 120 operates in the autonomous driving mode.

In addition, the steering shaft motor 120 rotates the steering shaft 103 so that the autonomous steering can be performed under the control of the electronic control device 110 without the involvement of the driver's driving or intention when the steering shaft motor 120 operates in the autonomous driving mode.

Further, in a steer-by-wire steering apparatus, because the steering wheel 101 is not mechanically connected to the rack bar 130 and a road wheel 131, a device for mechanically restricting or limiting a rotatable range of the steering wheel 101 may be included to prevent the steering shaft 103 from rotating infinitely when the driver manipulates the steering wheel 101.

For example, a rotation angle restriction device 125 may be provided to restrict or limit a rotatable range of the steering wheel 101 to prevent the steering shaft 103 from rotating infinitely.

The first motor 145 and the second motor 147 move the rack bar 130 or cause the rack bar 130 to slide by a rack bar moving device 140 in order to steer the road wheels 131, which are provided at or connected to two opposite sides of the rack bar 130 through tie rods 133 and knuckle arms 135 by sliding the rack bar 130.

The rack bar moving device 140 includes the ball nut 141, the first nut pulley 143a, the second nut pulley 143b, the first motor pulley 142a, and the second motor pulley 142b. The ball nut 141 may be rotatably coupled to the rack bar 130 by means of the balls 144 and configured to slide the rack bar 130 in the axial direction of the rack bar moving device 140 by the rotation of the ball nut 141. The first nut pulley 143a may be provided on one side of the outer peripheral surface of the ball nut 141, and the second nut pulley 143b may be provided on the other side of the outer peripheral surface of the ball nut 141. The first motor pulley 142a may be coupled to the first motor 145 (e.g. fixed to a shaft of the first motor 145) or directly formed on a rotatable part of the first motor 145 and connected to the first nut pulley 143a through the first belt 149a. The second motor pulley 142b may be coupled to the second motor 147 (e.g. fixed to a shaft of the second motor 147) or directly formed on a rotatable part of the second motor 147 and connected to the second nut pulley 143b through the second belt 149a.

Further, the balls 144 are rotatably disposed between a rack screw groove, which is formed on an outer peripheral surface of the rack bar 130, and a nut screw groove, formed on an inner peripheral surface of the ball nut 141, such that the rack bar 130 can slides in the axial direction of the rack bar moving device 140 by the rotation of the ball nut 141.

However, in the embodiments of the present disclosure described above, the angle sensor 105 and the torque sensor 107 are provided on or around the steering shaft 103, and the steering apparatus according to an embodiment of the present disclosure may comprise a vehicle speed sensor 102, an ultrasonic sensor 104, and an image sensor 106 for transmitting steering information to the electronic control device 110. However, various types of sensors, such as a radar and a lidar, may be added to an embodiment of the present disclosure.

In a steer-by-wire steering apparatus, because the steering wheel 101 is not mechanically connected to the rack bar 130 and the road wheel 131, a device mechanically restricting the rack bar 130 may be included to prevent the rack bar 130 from being rotated by rotational torque of the ball nut 141 rotated by the rack bar moving device 140.

For instance, a rotation prevention member 150 is configured to support the axial sliding of the rack bar 130 and prevent the rotation of the rack bar 130.

In an embodiment illustrated in FIG. 1, one single rotation prevention member 150 is provided at one side of the rack bar 130. Alternatively, a plurality of the rotation prevention members 150 may be provided to support the rack bar 130. The number of the rotation prevention members 150, an axial position of the rotation prevention member 150, or the like may vary depending on the configuration and required operations of the first and second motors 145 and 147 and necessary rotational force of the ball nut 141 of the rack bar moving device 140.

In one embodiment illustrated in FIG. 1, the first motor 145 and the second motor 147 are arranged to face each other such that a shaft 145a of the first motor 145 and a shaft 147a of the second motor 147 are aligned coaxially and disposed in parallel with a central axis of the rack bar 130.

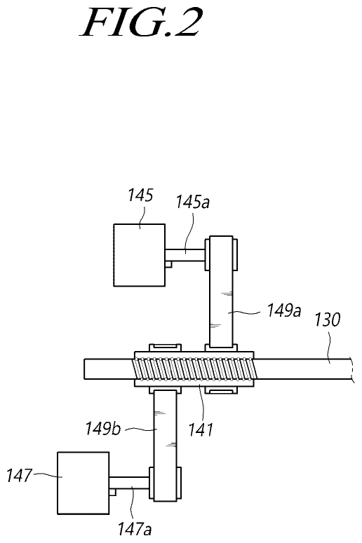

In an another embodiment illustrated in FIG. 2, the first motor 145 is disposed on one side of the rack bar 130 and the second motor 147 is disposed on the other side of the rack bar 130 such that the rack bar 130 is positioned between the shaft 145a of the first motor 145 and the shaft 147a of the second motor 147, and the shaft 145a of the first motor 145 and the shaft 147a of the second motor 147 are disposed in parallel with the central axis of the rack bar 130 and disposed on two opposite sides of the central axis of the rack bar 130.

As described above, the exemplary arrangements of the first and second motors 145 and 147 and the rack bar 130 illustrated in FIGS. 1 and 2 may reduce the package size of the steering apparatus, making it more compact in volume, and the process of assembling of the steering apparatus the first motor 145, the first belt 149a, the second motor 147, and the second belt 149b may be simplified.

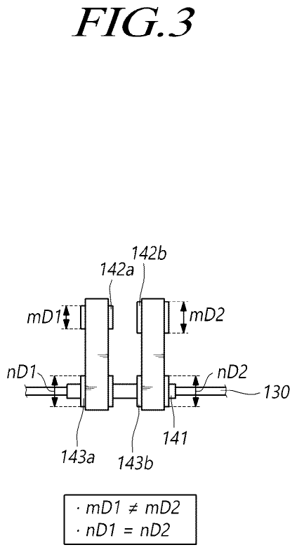

With reference to FIG. 3, an outer diameter mD1 of the first motor pulley 142a and an outer diameter mD2 of the second motor pulley 142b may be different from each other, and an outer diameter nD1 of the first nut pulley 143a and an outer diameter nD2 of the second nut pulley 143b may be equal to each other.

That is, the first nut pulley 143a and the second nut pulley 143b rotate while maintaining the same phase angle without a phase difference therebetween when the first motor 145 and the second motor 147 operate. The first motor pulley 142a and the second motor pulley 142b rotate while gradually changing a phase difference therebetween when the first motor 145 and the second motor 147 operate.

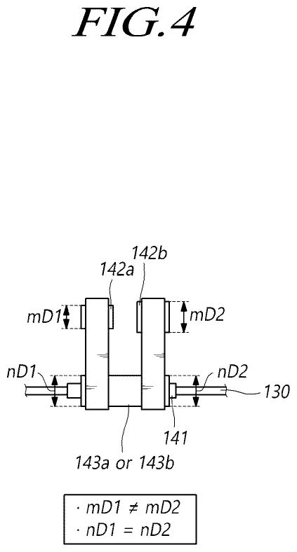

In an embodiment illustrated in FIG. 3, the first nut pulley 143a and the second nut pulley 143b are provided separately and connected to one portion and the other portion of the outer peripheral surface of the ball nut 141. However, as illustrated in FIG. 4, the first nut pulley 143a and the second nut pulley 143b may be integrated as a single piece having the same outer diameter. This will be described below.

The first motor 145 may have a first motor sensor 145s configured to detect a rotation position of the shaft 145a of the first motor 145, and the second motor 147 may have a second motor sensor 147s configured to detect a rotation position of the shaft 147a of the second motor 147.

When the first motor 145 operates, the first motor sensor 145s detects a direction and an angle of rotation of the shaft 145a of the first motor 145, and the first motor sensor 145s outputs a signal indicative of the direction and the angle to the electronic control device 110.

When the second motor 147 operates, the second motor sensor 147s detects a direction and an angle of rotation of the shaft 147a of the second motor 147, and the second motor sensor 147s outputs a signal indicative of the direction and the angle of the rotation of the shaft 147a of the second motor 147 to the electronic control device 110. When the second motor 147 operates, the second motor sensor 147s detects a direction and an angle of rotation of the shaft 147a of the second motor 147, and the second motor sensor 147s outputs a signal indicative of the direction and the angle of rotation of the shaft 147a of the second motor 147 to the electronic control device 110.

Therefore, the electronic control device 110 may determine a linear position of the rack bar 130 based on a first position of the shaft 145a of the first motor 145 detected by the first motor sensor 145s and a second position of the shaft 147a of the second motor 147 detected by the second motor sensor 147s and output a control signal to the first motor 145 and the second motor 147.

That is, the electronic control device 110 sets an angle between a reference point of the shaft 145a of the first motor 145 in a stopped state of the first motor 145 and a reference point of the shaft 147a of the second motor 147 in a stopped state of the second motor 147 to a reference position value. The electronic control device 10 sets an angle between the reference point of the shaft 145a of the first motor 145 and the reference point of the shaft 147a of the second motor 147 after the operations of the first and second motors 145 and 147 to an operating position value. The electronic control device 10 determines the linear position of the rack bar 130 based on a difference between the reference position value and the operating position value.

For instance, the difference between the reference position value and the operating position value may be set to 0° to 360°. A maximum slidable amount of the rack bar 130 is set within this range. The electronic control device 110 determines the slidable position of the rack bar 130 based on at least one of a rotation ratio between the first motor pulley 142a and the first nut pulley 143a, a rotation ratio between the second motor pulley 142b and the second nut pulley 143b, an outer diameter and an inner diameter of the ball nut 141, an outer diameter of the rack bar 130, or a lead angle between the rack screw groove 130a and the nut screw groove 141a.

In addition, the electronic control device 110 may determine the linear position of the rack bar 130 by setting the difference between the reference position value and the operating position value to a movement value and comparing the movement value with preset data. For instance, the movement value may be set to 0° to 360°, and the maximum slidable amount of the rack bar 130 may be set within this range.

The preset data may be data including the sliding amount of the rack bar 130 corresponding to the movement value determined based on at least one of the outer diameters of the first and second motor pulleys 142a and 142b, the outer diameters of the first and second nut pulleys 143a and 143b, the outer and inner diameters of the ball nut 141, and/or the outer diameter of the rack bar 130.

For example, the first motor pulley 142a and the second motor pulley 142b have different outer diameters, and the first nut pulley 143a and the second nut pulley 143b have the same outer diameter, such that the electronic control device 110 may determine the sliding position of the rack bar 130 based on the first position of the shaft 145a of the first motor 145 detected by the first motor sensor 145s and the second position of the shaft 147a of the second motor 147 detected by the second motor sensor 147s and output a signal for controlling the first motor 145 and the second motor 147.

With reference to FIG. 4, the first nut pulley 143a and the second nut pulley 143b may be integrated to a single piece having the same outer diameter.

In an example that the first nut pulley 143a and the second nut pulley 143b are integrated to a single piece having the same outer diameter, the first belt 149a is coupled to one portion of the integrated pulley, and the second belt 149b is coupled to the other portion of the integrated pulley, such that the first belt 149a and the second belt 149b may be respectively connected to the first motor pulley 142a and the second motor pulley 142b.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

When the first motor 145 operates, the first motor sensor 145s detects the direction and the angle of the rotation of the shaft 145a of the first motor 145, and the first motor sensor 145s transmits the direction and the angle to the electronic control device 110.

When the second motor 147 operates, the second motor sensor 147s detects the direction and the angle of the rotation of the shaft 147a of the second motor 147 rotates, and the second motor sensor 147s transmits a signal indicative of the direction and the angle to the electronic control device 110.

Therefore, the electronic control device 110 may determine the linear position of the rack bar 130 based on the first position of the shaft 145a of the first motor 145 detected by the first motor sensor 145s and the second position of the shaft 147a of the second motor 147 detected by the second motor sensor 147s and output a signal for controlling the first motor 145 and the second motor 147.

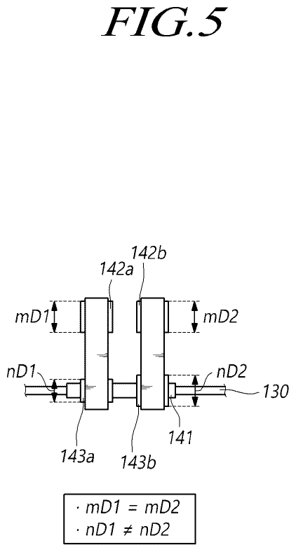

In an exemplary embodiment illustrated in FIG. 5, the outer diameter mD1 of the first motor pulley 142a and the outer diameter mD2 of the second motor pulley 142b may be equal to each other, and the outer diameter nD1 of the first nut pulley 143a and the outer diameter nD2 of the second nut pulley 143b may be different from each other.

The first nut pulley 143a, the second nut pulley 143b, and the ball nut 141 rotate at the same speed. Therefore, the first nut pulley 143a and the second nut pulley 143b maintain the same phase angle and rotate without a phase difference when the first motor 145 and the second motor 147 operate. However, the first motor pulley 142a and the second motor pulley 142b rotate while gradually changing a phase difference.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

When the first motor 145 operates, the first motor sensor 145s detects the direction and the angle of rotation of the shaft 145a of the first motor 145, and the first motor sensor 145s outputs a signal indicative of the direction and the angle of the rotation of the shaft 145a of the first motor 145 to the electronic control device 110.

Further, when the second motor 147 operates, the second motor sensor 147s detects the direction and the angle of rotation of the shaft 147a of the second motor 147, and the second motor sensor 147s transmits the direction and the angle of the rotation of the shaft 147a of the second motor 147 to the electronic control device 110.

Therefore, the electronic control device 110 may output a signal for controlling the first motor 145 and the second motor 147 by determining the linear position of the rack bar 130 through the above-mentioned determination process based on the first position of the shaft 145a of the first motor 145 detected by the first motor sensor 145s and the second position of the shaft 147a of the second motor 147 detected by the second motor sensor 147s.

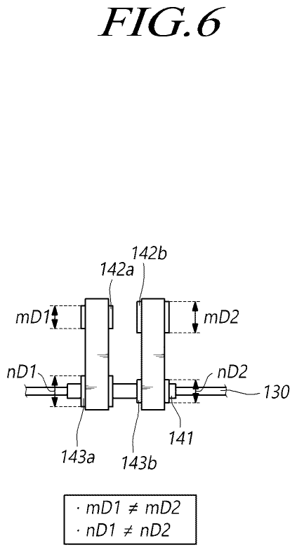

In an exemplary embodiment shown in FIG. 6, the outer diameter mD1 of the first motor pulley 142a and the outer diameter mD2 of the second motor pulley 142b may be different from each other, and the outer diameter nD1 of the first nut pulley 143a and the outer diameter nD2 of the second nut pulley 143b may also be different from each other.

Even in this case, the first nut pulley 143a, the second nut pulley 143b, and the ball nut 141 rotate at the same speed. Therefore, the first nut pulley 143a and the second nut pulley 143b maintain the same phase angle and rotate without a phase difference when the first motor 145 and the second motor 147 operate.

Further, the first motor pulley 142a and the second motor pulley 142b rotate while gradually changing a phase difference when the first motor 145 and the second motor 147 operate.

The first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may output a signal for controlling the first motor 145 and the second motor 147 by determining the linear position of the rack bar 130 through the above-mentioned determination process based on the first position of the shaft 145a of the first motor 145 detected by the first motor sensor 145s and the second position of the shaft 147a of the second motor 147 detected by the second motor sensor 147s.

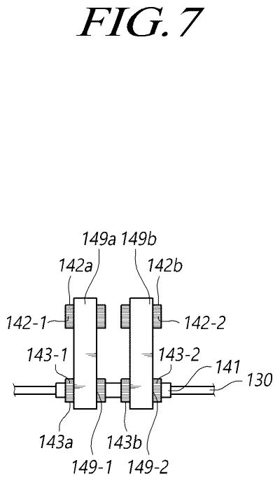

In an exemplary embodiment of FIG. 7, first motor pulley teeth 142-1 are provided on an outer peripheral surface of the first motor pulley 142a, and first nut pulley teeth 143-1 are provided on an outer peripheral surface of the first nut pulley 143a. The first motor pulley teeth 142-1 and the first nut pulley teeth 143-1 may be coupled to first belt teeth 149-1 provided on an inner peripheral surface of the first belt 149a.

Because the first motor pulley teeth 142-1 and the first nut pulley teeth 143-1 are coupled to the first belt teeth 149-1 to transmit power, the first motor pulley teeth 142-1 and the first nut pulley teeth 143-1 have the same size as the first belt teeth 149-1.

Second motor pulley teeth 142-2 are provided on an outer peripheral surface of the second motor pulley 142b, and second nut pulley teeth 143-2 are provided on an outer peripheral surface of the second nut pulley 143b. The second motor pulley teeth 142-2 and the second nut pulley teeth 143-2 may be coupled to second belt teeth 149-2 provided on an inner peripheral surface of the second belt 149b.

Because the second motor pulley teeth 142-2 and the second nut pulley teeth 143-2 are coupled to the second belt teeth 149-2 to transmit power, the second motor pulley teeth 142-2 and the second nut pulley teeth 143-2 may have the same size as the second belt teeth 149-2.

Further, the number of the first motor pulley teeth 142-1 and the number of the second motor pulley teeth 142-2 may be different from each other, and the number of the first nut pulley teeth 143-1 and the number of the second nut pulley teeth 143-2 may be equal to each other.

The first motor pulley teeth 142-1 and the second motor pulley teeth 142-2 have an equal circumferential pitch, different pitch circle diameters, and a different number of teeth from each other. The first nut pulley teeth 143-1 and the second nut pulley teeth 143-2 have an equal circumferential pitch, an equal pitch circle diameter, and a different number of teeth.

The first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may determine the linear position of the rack bar 130 based on the first position of the shaft 145a of the first motor 145 detected by the first motor sensor 145s and the second position of the shaft 147a of the second motor 147 detected by the second motor sensor 147s and output a signal for controlling the first motor 145 and the second motor 147.

That is, like the above-mentioned determination method, the difference between the reference position value and the operating position value may be set to 0° to 360°, and the maximum slidable amount of the rack bar 130 is set within this range. The electronic control device 110 determines the sliding position of the rack bar 130 on the basis of at least one of a pitch circle diameter ratio or a tooth number ratio between the first motor pulley 142a and the first nut pulley 143a, a pitch circle diameter ratio or a tooth number ratio between the second motor pulley 142b and the second nut pulley 143b, the outer and inner diameters of the ball nut 141, or the outer diameter of the rack bar 130.

In addition, like the above-mentioned determination method, the electronic control device 110 may determine the sliding position of the rack bar 130 by setting the difference between the reference position value and the operating position value to the movement value and comparing the movement value with preset data. In this case, the movement value may be set to 0° to 360°, and the maximum slidable amount of the rack bar 130 is set within this range.

In this case, the preset data may be data including the sliding amount of the rack bar 130 corresponding to the movement value determined based on at least one of the pitch circle diameters and the number of teeth of the first and second motor pulleys 142a and 142b, the pitch circle diameters and the number of teeth of the first and second nut pulleys 143a and 143b, the outer and inner diameters of the ball nut 141, and/or the outer diameter of the rack bar 130.

As described above, the number of the first motor pulley teeth 142-1 and the number of the second motor pulley teeth 142-2 are different, and the number of the first nut pulley teeth 143-1 and the number of the second nut pulley teeth 143-2 are equal. The electronic control device 110 may output a signal for controlling the first motor 145 and the second motor 147 by determining the sliding position of the rack bar 130 on the basis of the first position of the shaft 145a of the first motor 145 sensed by the first motor sensor 145s and the second position of the shaft 147a of the second motor 147 detected by the second motor sensor 147s.

In addition, the number of the first motor pulley teeth 142-1 and the number of the second motor pulley teeth 142-2 may be equal, and the number of the first nut pulley teeth 143-1 and the number of the second nut pulley teeth 143-2 may be different.

The first motor pulley teeth 142-1 and the second motor pulley teeth 142-2 have an equal circumferential pitch and an equal pitch circle diameter, and the same number of teeth. The first nut pulley teeth 143-1 and the second nut pulley teeth 143-2 have an equal circumferential pitch, and different pitch circle diameters and the different number of teeth.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may output a signal for controlling the first motor 145 and the second motor 147 by determining the sliding position of the rack bar 130 through the above-mentioned determination process based on the first position of the shaft 145a of the first motor 145 detected by the first motor sensor 145s and the second position of the shaft 147a of the second motor 147 detected by the second motor sensor 147s.

In addition, the number of the first motor pulley teeth 142-1 and the number of the second motor pulley teeth 142-2 may be different, and the number of the first nut pulley teeth 143-1 and the number of the second nut pulley teeth 143-2 may be different.

That is, the first motor pulley teeth 142-1 and the second motor pulley teeth 142-2 may have an equal circumferential pitch and different pitch circle diameters, and different number of teeth. The first nut pulley teeth 143-1 and the second nut pulley teeth 143-2 have an equal circumferential pitch, different pitch circle diameters, and different number of teeth.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may output a signal for controlling the first motor 145 and the second motor 147 by determining the sliding position of the rack bar 130 through the above-mentioned determination process based on the first position of the shaft 145a of the first motor 145 detected by the first motor sensor 145s and the second position of the shaft 147a of the second motor 147 the second motor sensor 147s.

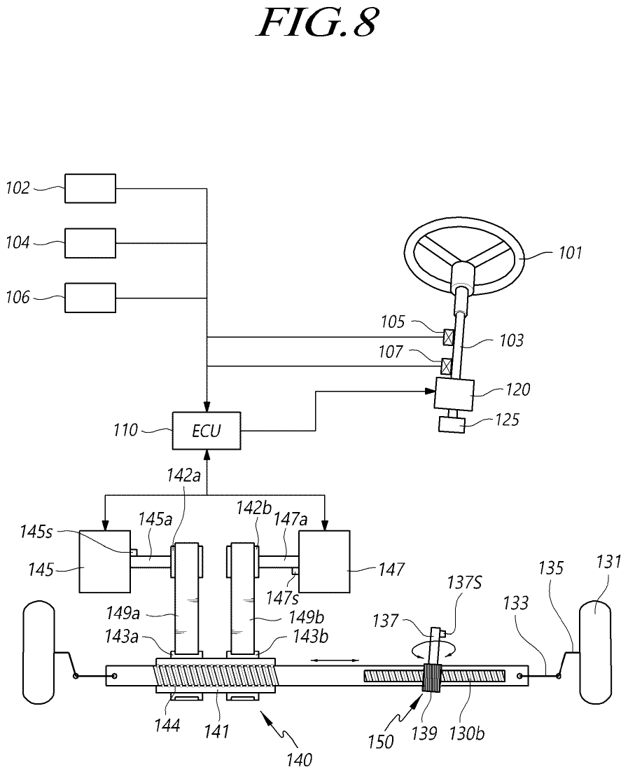

In an exemplary embodiment of FIG. 8, in order to prepare for a case in which any one of the first motor sensor 145s and the second motor sensor 147s is inoperable, a rotary gear 139, rotatably engaged with a rack gear 130b provided on the rack bar 130, may be rotatably coupled to the rack bar 130, and a rotation angle sensor 137s may be configured to detect a rotation angle of the rotary gear 139.

The rotary gear 139 may be configured to be rotatable while being supported on a rack housing by means of a bearing. The rotation angle sensor 137s may be installed on or around a shaft 137 of the rotary gear 139 and configured to detect a rotation angle of the rotary gear 139 and transmit the rotation angle of the rotary gear 139 to the electronic control device 110.

Therefore, even when any one of the first motor sensor 145s and the second motor sensor 147s is inoperable, the electronic control device 110 may output a signal for controlling the first motor 145 and the second motor 147 by determining the sliding position of the rack bar 130 based on the pre-stored gear ratio between the rack gear 130b and the rotary gear 139 and the rotation angle of the rotary gear 139 received from the rotation angle sensor 137s.

Meanwhile, hereinafter, various embodiments of a rotation prevention member or means may be provided in the above-mentioned steering apparatus.

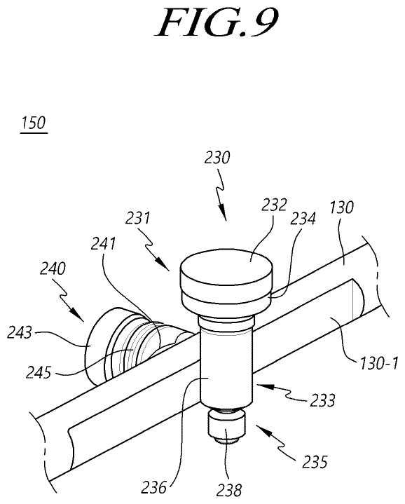

Some embodiments of the rotation prevention member 150 will be described below more specifically with reference to FIGS. 9 to 18.

As illustrated in FIG. 9, the rotation prevention member 150 may be coupled to one radial side and the other radial side of the rack bar 130 and support two opposite sides of the rack bar 130, thereby preventing the rack bar 130 from rotating.

The rotation prevention member 150 may include a shaft 230 configured to support a support surface 130-1 formed on the outer peripheral surface of the rack bar 130, and a support yoke 240 configured to support the outer peripheral surface of the rack bar 130 opposite or corresponding to a position at which the shaft 230 is supported.

The support surface 130-1 formed on the outer peripheral surface of the rack bar 130 may be formed by machining or grinding the outer peripheral surface of the rack bar 130.

The support surface 130-1 may be recessed from the outer peripheral surface of the rack bar 130 and formed as a curved surface, a flat surface, or combination thereof.

The support surface 130-1 extends in an axial direction of the rack bar 130 so as to be supported by the shaft 230 when the rack bar 130 slides in the axial direction of the rack bar 130.

Optionally, a coating layer may be provided on the support surface 130-1 and made of a low-friction material having a low frictional coefficient, such as fluorine resin or ceramic, in order to minimize or reduce friction with the shaft 230.

The shaft 230, which supports the support surface 130-1 of the rack bar 130, may include an upper end support portion 231, a body portion 233, and a lower end support portion 235.

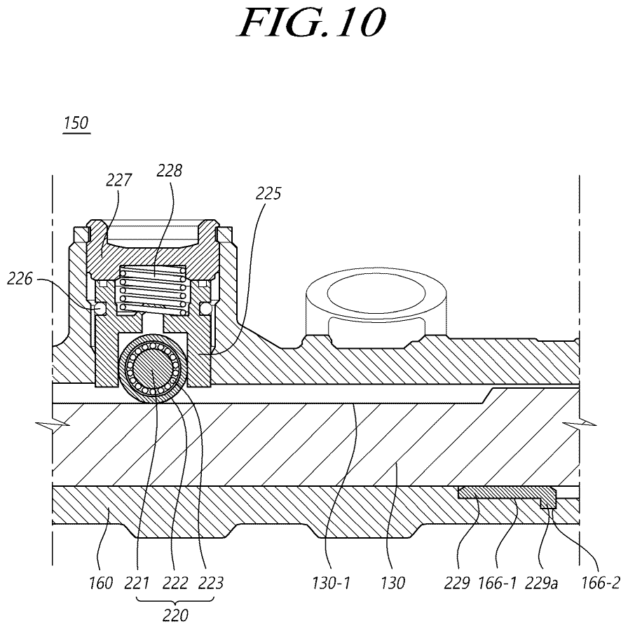

When the rack bar 130 slides, the shaft 230 is supported by a rack housing (e.g., 160 of FIG. 10) and is configured to be rotatable such that the body portion 233 supports the support surface 130-1 of the rack bar 130, thereby preventing the rack bar 130 from rotating.

A needle bearing 236 may be coupled to the body portion 233 to minimize or reduce friction with the support surface 130-1 of the rack bar 130.

The upper end support portion 231, which has a larger diameter than the body portion 233, may be provided above the body portion 233, and an upper end bearing 234 may be coupled to the upper end support portion 231 so as to be rotatably supported on the rack housing.

A top plug 232 may be coupled to an upper side of the upper end support portion 231 in order to prevent foreign substances from being introduced into the rack housing.

The lower end support portion 235, which has a smaller diameter than the body portion 233, may be provided below the body portion 233, and a lower end bearing 238 may be coupled to the lower end support portion 235 so as to be rotatably supported on the rack housing.

The support yoke 240, which supports the outer peripheral surface of the rack bar 130 opposite to a position at which the shaft 230 is supported, supports the rack bar 130 toward the shaft 230 when the rack bar 130 slides, thereby preventing the rack bar 130 from rotating.

A curved surface support portion 241 may be formed at an end portion of the support yoke 240 and may be supported on and closely contacted with the outer peripheral surface of the rack bar 130. The curved surface support portion 241 may have a curved surface identical to the outer peripheral surface of the rack bar 130.

The support yoke 240 may have predetermined rigidity and elasticity and may be made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

An elastic ring 245 may be coupled to an outer peripheral surface of the support yoke 240 to prevent rattle noise with the rack housing.

One or more elastic rings 245 may be coupled to the outer peripheral surface of the support yoke 240.

The elastic ring 245 may be made of a material capable of absorbing vibration and noise and having predetermined elasticity and rigidity. For instance, the elastic ring 245 may be made of one or more materials selected from a group consisting of natural rubber (NR), nitrile butadiene rubber (NBR), chloroprene rubber (CR), ethylene propylene terpolymer (EPDM), fluoro-rubber (FPM), styrene butadiene rubber (SBR), chlorosulfonated polyethylene (CSM), urethane, and silicone that have the above-mentioned properties.

A yoke plug 243 may be coupled to an end portion of the support yoke 240, press-fitted or screw-coupled to the rack housing, and fix the support yoke 240.

Further, an elastic body may be coupled between the support yoke 240 and the yoke plug 243 and elastically support the support yoke 240 toward the rack bar 130.

As illustrated in FIG. 10, the rotation prevention member 150 may be coupled to one radial side and the other radial side of the rack bar 130 and support two opposite sides of the rack bar 130, thereby preventing the rack bar 130 from rotating.

The rotation prevention member 150 may include a needle bearing 220 configured to support the support surface 130-1 formed on the outer peripheral surface of the rack bar 130, a support yoke 225 rotatably coupled to the needle bearing 220, and a rack bushing 229 configured to support the outer peripheral surface of the rack bar 130 opposite to a position at which the needle bearing 220 is supported.

The support surface 130-1 may be formed on the outer peripheral surface of the rack bar 130. For instance, the support surface 130-1 may be formed by machining or grinding the outer peripheral surface of the rack bar 130.

The support surface 130-1 may be recessed from the outer peripheral surface of the rack bar 130. The support surface 130-1 may be formed as a curved surface or a flat surface.

The support surface 130-1 is elongated in the axial direction of the rack bar 130. And, the support surface 130-1 may be supported by the needle bearing 220 when the rack bar 130 slides in the axial direction of the rack bar 130.

A coating layer may be provided on the support surface 130-1 and made of a low-friction material, such as fluorine resin or ceramic, in order to minimize or reduce friction with the needle bearing 220.

The needle bearing 220 may be configured to support the support surface 130-1 of the rack bar 130, the needle bearing 220 may have a support shaft 221 provided at a central portion of the needle bearing 220, and the support shaft 221 is fixed to the support yoke 225 so that the needle bearing 220 may be rotatably supported by the support yoke 225.

An outer race 222 of the needle bearing 220 is supported on the support surface 130-1 and is configured to rotate when the rack bar 130 slides in order to prevent the rack bar 130 from rotating.

The outer race 222 of the needle bearing 220 may be disposed at a position protruding from an end portion of the support yoke 225 so that the outer race 222 may be supported on the support surface 130-1.

The support yoke 225 supports the needle bearing 220 toward the support surface 130-1 when the rack bar 130 slides in order to prevent the rotation of the rack bar 130.

The support yoke 225 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

An elastic ring 226 may be coupled to the outer peripheral surface of the support yoke 225 to prevent rattle noise with the rack housing 160.

One or more elastic rings 226 may be coupled to the outer peripheral surface of the support yoke 225.

The elastic ring 226 may be made of a material capable of absorbing vibration and noise and having predetermined elasticity and rigidity. Therefore, the elastic ring 226 may be made of one or more materials selected from a group consisting of natural rubber (NR), nitrile butadiene rubber (NBR), chloroprene rubber (CR), ethylene propylene terpolymer (EPDM), fluoro-rubber (FPM), styrene butadiene rubber (SBR), chlorosulfonated polyethylene (CSM), urethane, and silicone that have the above-mentioned properties.

A yoke plug 227 may be coupled to an end of the support yoke 225, press-fitted or screw-coupled to the rack housing 160, and configured to fix the position of the support yoke 225.

Further, an elastic body 228 may be coupled between the support yoke 225 and the yoke plug 227 and elastically support the support yoke 225 by applying an elastic force toward the rack bar 130.

The rack bushing 229, which supports the outer peripheral surface of the rack bar 130 opposite to another outer peripheral surface of the rack bar 130 which the needle bearing 220 supports, may be formed in a semi-cylindrical shape made by cutting a part of an outer peripheral surface thereof.

The rack bushing 229 supports the rack bar 130 toward the needle bearing 220 in the radial direction of the rack bushing 229 when the rack bar 130 slides, thereby preventing the rack bar 130 from rotating.

The rack bushing 229 may have a curved surface identical to or corresponding to the outer peripheral surface of the rack bar 130 so as to be closely contacted with and supported on the outer peripheral surface of the rack bar 130.

A bushing coupling groove 166-1, to which the rack bushing 229 is coupled, may be formed on an inner peripheral surface of the rack housing 160.

The rack bushing 229 may have a fixing protrusion 229a formed on or around an end portion of an outer peripheral surface of the rack bushing 229 in order to prevent the axial position of the rack bushing 229 from being separated or rotated when the rack bar 130 slides.

A fixing groove 166-2 may be formed on the inner peripheral surface of the rack housing 160, and the fixing protrusion 229a of the rack bushing 229 may be coupled to the fixing groove 166-2 of the rack housing 160.

The rack bushing 229 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

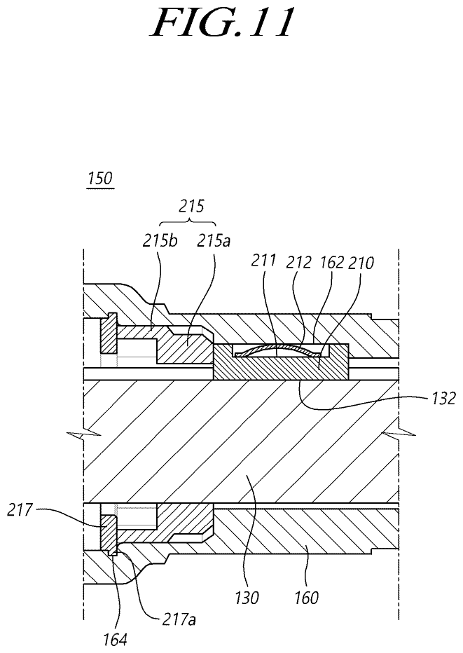

In an embodiment illustrated in FIG. 11, the rotation prevention member 150 may be configured to prevent the rack bar 130 from rotating about the central axis of the rack bar 130. The rotation prevention member 150 supports the outer peripheral surface of the rack bar 130 and may be supported on the inner peripheral surface of the rack housing 160.

The rotation prevention member 150 may include a support member 210 having one end portion disposed or supported in a rack support groove 132 formed on the outer peripheral surface of the rack bar 130, and the other end portion disposed or supported in a housing groove 162 formed on the inner peripheral surface of the rack housing 160, and an elastic member 212 coupled to the support member 210 and configured to elastically support the inner peripheral surface of the rack housing 160.

The rack support groove 132 formed on the outer peripheral surface of the rack bar 130 may be formed by machining or grinding the outer peripheral surface of the rack bar 130.

The rack support groove 132 may be recessed from the outer peripheral surface of the rack bar 130. The rack support groove 132 may have a curved surface or a flat surface.

The rack support groove 132 may be elongated in the axial direction of the rack bar 130 and be supported by the support member 210 when the rack bar 130 slides in the axial direction of the rack bar 130.

A coating layer may be provided on the rack support groove 132 and made of a low-friction material, such as fluorine resin or ceramic, in order to reduce or minimize friction with the support member 210.

The housing groove 162, in which the other end portion of the support member 210 is supported, may be formed at a position facing the rack support groove 132 in the radial direction of the rack bar 130.

For example, the housing groove 162 may be formed by machining or grinding the inner peripheral surface of the rack housing 160.

The housing groove 162 may be recessed from the inner peripheral surface of the rack housing 160 and have a curved surface or a flat surface so that the support member 210 can prevents the rotation of the rack bar 130 when the rack bar 130 slides in the axial direction of the rack bar 130.

One end portion and the other end portion of the support member 210 are coupled to the rack support groove 132 and the housing groove 162, respectively, and a coupling groove 211, to which the elastic member 212 is coupled, is formed at the other end portion of the support member 210.

The support member 210 may have predetermined rigidity and elasticity and be made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

The elastic member 212 is coupled to the coupling groove 211 of the support member 210, supports the support member 210 and is configured to apply elastic force toward the rack bar 130 while being elastically supported on the inner peripheral surface of the rack housing 160, such that the support member 210 maintains a predetermined interval so as not to collide with the inner peripheral surface of the rack housing 160 when the rack bar 130 slides in the axial direction of the rack bar 130. Therefore, rattle noise between the support member 210 and the rack housing 160 may be prevented.

For example, the elastic member 212 may be formed as an arcuate thin board.

A plug bolt 215 may be disposed at an axial end of the support member 210, may be configured to prevent the separation of the support member 210, and may be coupled to the inner peripheral surface of the rack housing 160. For instance, the plug bolt 215 may be press-fitted and coupled to the inner peripheral surface of the rack housing 160.

The plug bolt 215 includes a support portion 215a configured to support the support member 210 in the axial direction of the rack bar 130, and a fixing portion 215b extended from the support portion 215a and fixed to the inner peripheral surface of the rack housing 160.

The outer peripheral surface of the fixing portion 215b has a threaded portion screw-coupled to the inner peripheral surface of the rack housing 160.

Further, a fixing member 217 may be coupled to an axial end of the plug bolt 215 in order to prevent the plug bolt 215 from being loosened and separated.

A fixing protrusion 217a protruding in the radial direction of the rack housing 160 may project from an outer peripheral surface of the fixing member 217.

A fixing groove 164 may be formed on the inner peripheral surface of the rack housing 160, and the fixing protrusion 217a of the fixing member 217 may be inserted into and supported by the fixing groove 164.

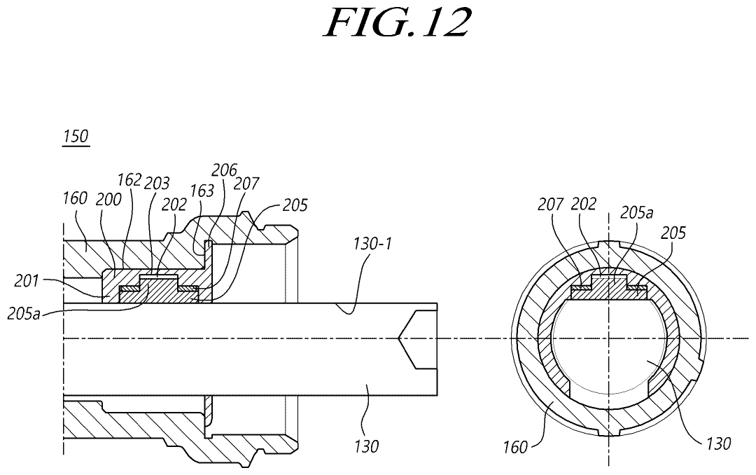

In an embodiment of FIG. 12, the rotation prevention member 150 may be supported on the outer peripheral surface of the rack bar 130 and the inner peripheral surface of the rack housing and prevent the rack bar 130 from rotating about the central axis.

The rotation prevention member 150 may include a support bushing 205 configured to support the support surface 130-1 formed on the outer peripheral surface of the rack bar 130, a bushing holder 200 coupled to the outer peripheral surface of the rack bar 130 and having an inner peripheral surface on which the support bushing 205 is supported, and an elastic member 207 coupled between the bushing holder 200 and the support bushing 205 and configured to elastically support the support bushing 205 by apply elastic force toward the rack bar 130.

For example, the support surface 130-1 formed on the outer peripheral surface of the rack bar 130 may be formed by machining or grinding the outer peripheral surface of the rack bar 130.

The support surface 130-1 may be recessed from the outer peripheral surface of the rack bar 130 and may have a curved surface or a flat surface.

The support surface 130-1 is elongated in the axial direction of the rack bar 130 and is supported by the support bushing 205 when the rack bar 130 slides in the axial direction.

A coating layer may be provided on the support surface 130-1 and made of a low-friction material, such as fluorine resin or ceramic, in order to minimize or reduce friction with the support bushing 205.

The housing groove 162, to and in which the bushing holder 200 is coupled and supported, is formed on the inner peripheral surface of the rack housing 160, and is positioned to face the support surface 130-1 in the radial direction of the rack bar 130.

For example, the housing groove 162 may be formed by machining or grinding the inner peripheral surface of the rack housing 160.

The housing groove 162 may be recessed from the inner peripheral surface of the rack housing 160 and may have a curved surface or a flat surface.

In addition, a stepped projection portion 163 having a larger diameter at an end portion of the housing groove 162 may be formed on the inner peripheral surface of the rack housing 160, and an end portion of the stepped projection portion 163 may have an opening in the axial direction of the rack bar 130.

The bushing holder 200 has a cylindrical shape. For instance, the bushing holder 200 may have a cut-out portion made by cutting one radial side of the bushing holder 200, and an inner peripheral protruding surface 201 which protrudes radially inward.

Further, a bushing coupling groove 203, to which the support bushing 205 is coupled, may be formed on the inner peripheral protruding surface 201. A flange portion 206 protrudes in the radial direction, is supported by or on the stepped projection portion 163 of the rack housing 160, and may be formed at an axial end of the bushing holder 200.

The flange portion 206 is supported by or on the stepped projection portion 163 to prevent the separation of the bushing holder 200 when the rack bar 130 slides in the axial direction.

The support bushing 205 coupled to the bushing coupling groove 203 of the bushing holder 200 includes a protruding support portion 205a protruding from a central portion of the support bushing 205, and the elastic member 207 is coupled to the protruding support portion 205a.

For example, the elastic member 207 may be formed in an annular shape and formed in a cone shape in which an inner peripheral surface and an outer peripheral surface of the elastic member 207 are stepped in the axial direction such that the protruding support portion 205a may be coupled to an inner peripheral surface of the elastic member 207.

The elastic member 207 elastically supports the support bushing 205 to apply elastic force toward the rack bar 130 and the elastic member 207 may be positioned between the bushing holder 200 and the support bushing 205, thereby forming a gap or space 202 so that the support bushing 205 cannot collide with the bushing holder 200 when the rack bar 130 slides in the axial direction to prevent or reduce rattle noise between the support bushing 205 and the bushing holder 200.

The bushing holder 200 and the support bushing 205 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

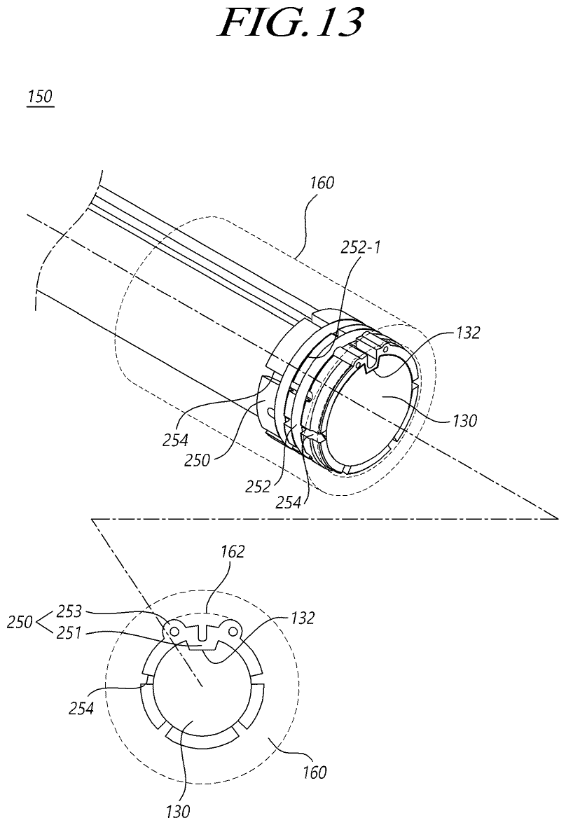

In an embodiment of FIG. 13, the rotation prevention member 150 may support the outer peripheral surface of the rack bar 130 to prevent the rack bar 130 from rotating about the central axis of the rotation prevention member 150 and may be supported by the inner peripheral surface of the rack housing 160.

The rotation prevention member 150 may include a rack bushing 250 having an inner peripheral support portion 251 inserted in and supported by the rack support groove 132 formed on the outer peripheral surface of the rack bar 130 and an outer peripheral support portion 253 inserted in and supported by the housing groove 162 formed on the inner peripheral surface of the rack housing 160, and an elastic member 252 coupled to the outer peripheral surface of the rack bushing 250 and configured to elastically support the rack bushing 250.

For example, the rack support groove 132 formed on the outer peripheral surface of the rack bar 130 may be formed by machining or grinding the outer peripheral surface of the rack bar 130.

The rack support groove 132 may be recessed from the outer peripheral surface of the rack bar 130 and may have a curved surface or a flat surface.

The rack support groove 132 is elongated in the axial direction of the rack bar 130 so as to be supported by the rack bushing 250 when the rack bar 130 slides in the axial direction.

A coating layer may be provided on the rack support groove 132 and made of a low-friction material, such as fluorine resin or ceramic, in order to minimize or reduce friction with the rack bushing 250.

The inner peripheral support portion 251 protrudes radially inward from the inner peripheral surface of the rack bushing 250 at a position facing the rack support groove 132.

The outer peripheral support portion 253 protrudes radially outward from the outer peripheral surface of the rack bushing 250 and is coupled to the housing groove 162.

For instance, the housing groove 162 may be formed by machining or grinding the inner peripheral surface of the rack housing 160.

The housing groove 162 may be recessed from the inner peripheral surface of the rack housing 160 and may have a curved surface or a flat surface.

Two or more outer peripheral support portions 253 may be formed on the outer peripheral surface of the rack bushing 250 and spaced apart from one another in a circumferential direction.

For instance, a pair of outer peripheral support portions 253 may be formed on the outer peripheral surface of the rack bushing 250 in the circumferential direction at a position corresponding to the inner peripheral support portion 251.

The rack bushing 250 may have predetermined rigidity and elasticity and be made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

The elastic member 252 may be coupled to the outer peripheral surface of the rack bushing 250 and have a ring shape.

The elastic member 252 may be made of a material capable of absorbing vibration and noise and have predetermined elasticity and rigidity. Therefore, the elastic member 252 may be made of one or more materials selected from a group consisting of natural rubber (NR), nitrile butadiene rubber (NBR), chloroprene rubber (CR), ethylene propylene terpolymer (EPDM), fluoro-rubber (FPM), styrene butadiene rubber (SBR), chlorosulfonated polyethylene (CSM), urethane, and silicone that have the above-mentioned properties.

A coupling groove 252-1, to which the elastic member 252 is coupled, may be formed on the outer peripheral surface of the rack bushing 250.

The rack bushing 250 may have a cut-out portion 254 cut in the axial direction so that the rack bushing 250 is deformable in the radial direction.

Two or more cut-out portions 254 spaced apart from one another in the circumferential direction may be provided.

The cut-out portions 254 may be formed such that one end or the other end of the rack bushing 250 is opened at a position wherein the cut-out portion 254 is formed.

The cut-out portions 254 opened at one end of the rack bushing 250 and the cut-out portion 254 opened at the other end of the rack bushing 250 may be spaced apart from each other in the circumferential direction and formed in a staggered manner.

Therefore, the rack bushing 250 is elastically supported in the radial direction by elastic force of the elastic member 252 so that the rack bushing 250 cannot collide with the rack housing 160 when the rack bar 130 slides in the axial direction to prevent or reduce rattle noise between the rack bushing 250 and the rack housing 160.

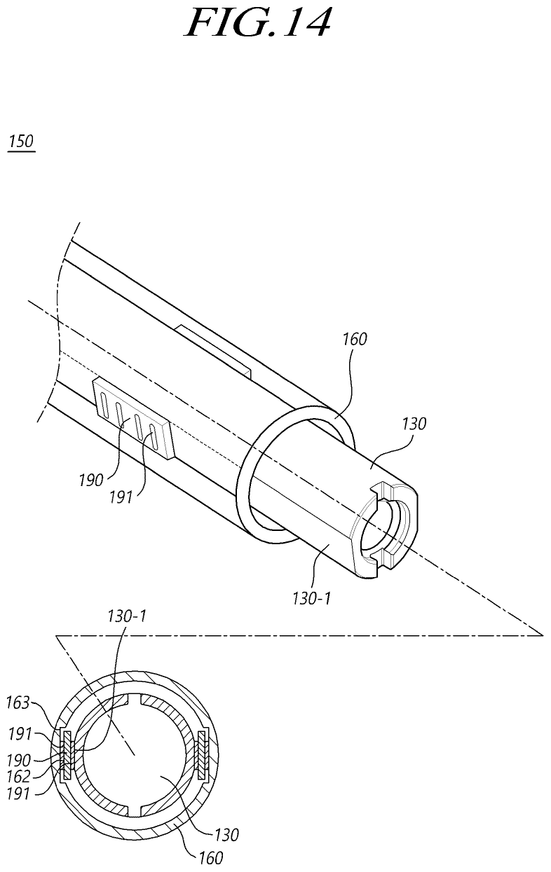

In an embodiment illustrated in FIG. 14, the rotation prevention member 150 may support the outer peripheral surface of the rack bar 130 to prevent the rack bar 130 from rotating about the central axis of the rack bar 130 and may be supported by the inner peripheral surface of the rack housing 160.

The rotation prevention member 150 may include a rotary member 191 configured to support the support surface 130-1 formed on the outer peripheral surface of the rack bar 130, and a support bushing 190 coupled to the housing groove 162 formed on the inner peripheral surface of the rack housing 160 and configured such that the rotary member 191 is rotatably coupled to the support bushing 190.

For instance, the support surface 130-1 formed on the outer peripheral surface of the rack bar 130 may be formed by machining or grinding the outer peripheral surface of the rack bar 130.

The support surface 130-1 may be recessed from the outer peripheral surface of the rack bar 130 and have a curved surface or a flat surface.

The support surface 130-1 is elongated in the axial direction of the rack bar 130 so as to be supported by the rotary member 191 when the rack bar 130 slides in the axial direction.

Two or more support surfaces 130-1 may be formed on the outer peripheral surface of the rack bar 130 and spaced apart from one another in the circumferential direction of the rack bar 130.

For instance, a pair of support surfaces 130-1 may formed at opposite sides of the rack bar 130 with respect to the center of the rack bar 130.

The rotary members 191 may be configured as a roller or ball movably disposed in an inner surface of the support bushing 190 (e.g. within one or more elongated holes of the support bushing 190) and configured to be rotatable or rollable while being supported on the support surface 130-1 of the rack bar 130.

The rotary members 191 may be rotatably supported on both the inner and outer surfaces of the support bushing 190.

A coating layer may be provided on the support surface 130-1 and made of a low-friction material, such as fluorine resin or ceramic, in order to reduce or minimize friction with the rotary member 191.

The housing groove 162, in which the support bushing 190 is disposed, is formed on the inner peripheral surface of the rack housing 160 at a position facing a support surface 130-1 of the rotary member 191 in the radial direction.

The support bushing 190 is coupled to the housing groove 162 of the rack housing 160, and the rotary member 191 is rotatably coupled to the support bushing 190.

The support bushing 190 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

For instance, the housing groove 162 may be formed by machining or grinding the inner peripheral surface of the rack housing 160.

The housing groove 162 may be recessed from the inner peripheral surface of the rack housing 160 and may have a curved surface or a flat surface.

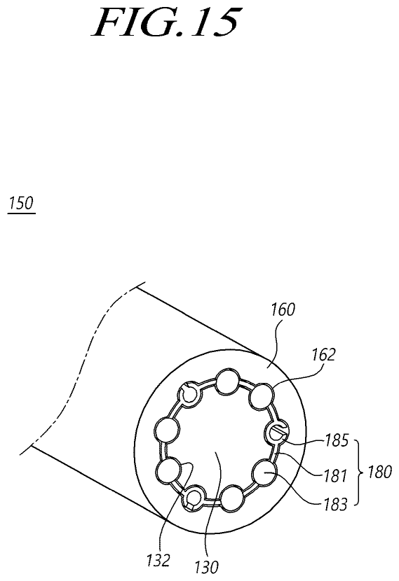

In an embodiment illustrated in FIG. 15, the rotation prevention member 150 may support the outer peripheral surface of the rack bar 130 to prevent the rack bar 130 from rotating about the central axis and is supported by the inner peripheral surface of the rack housing.

The rotation prevention member 150 may include a rack bushing 180 having one or more rotation support portions 183 rotatably disposed between the rack support groove 132 formed on the outer peripheral surface of the rack bar 130 and the housing groove 162 formed on the inner peripheral surface of the rack housing 160, an elastic support portion 185 disposed between and elastically supported by the rack support groove 132 formed on the outer peripheral surface of the rack bar 130 and the housing groove 162 formed on the inner peripheral surface of the rack housing 160, and a connection portion 181 connecting the rotation support portion 183 and the elastic support portion 185.

The rack support groove 132 may be formed on the outer peripheral surface of the rack bar 130. For instance, the rack support groove 132 may be formed by machining or grinding the outer peripheral surface of the rack bar 130.

The rack support groove 132 may be recessed from the outer peripheral surface of the rack bar 130, and include a curved surface or a flat surface.

The rack support groove 132 is elongated in the axial direction of the rack bar 130 and is supported by the rotation support portion 183 and the elastic support portion 185 when the rack bar 130 slides in the axial direction. The rotation support portion 183 and the elastic support portion 185 may be disposed in the rack support groove 132.

The housing groove 162 is formed on the inner peripheral surface of the rack housing 160 at the position facing or corresponding to the rack support groove 132 in the radial direction.

For instance, the housing groove 162 may be formed by machining or grinding the inner peripheral surface of the rack housing 160.

The housing groove 162 may be recessed from the inner peripheral surface of the rack housing 160 and may have a curved surface or a flat surface.

A coating layer may be provided on the rack support groove 132 and the housing groove 162 and made of a low-friction material, such as fluorine resin or ceramic, in order to minimize or reduce friction with the rack bushing 180.

The rack bushing 180 may have two or more rotation support portions 183 and/or two or more elastic support portions 185.

Balls may be coupled to the rotation support portions 183, and the balls may be spaced apart from one another in the axial direction.

The elastic support portion 185 may have a substantially cylindrical shape. The elastic support portion 185 may have an opening at one side thereof.

The rack bushing 180 is elastically supported by the rack support groove 132 and the housing groove 162 by an elastic deformation force of the elastic support portion 185, thereby maintaining a predetermined interval so that the rack bushing 180 does not collide with the rack housing 160 when the rack bar 130 slides in the axial direction to prevent rattle noise between the rack bushing 180 and the rack housing 160.

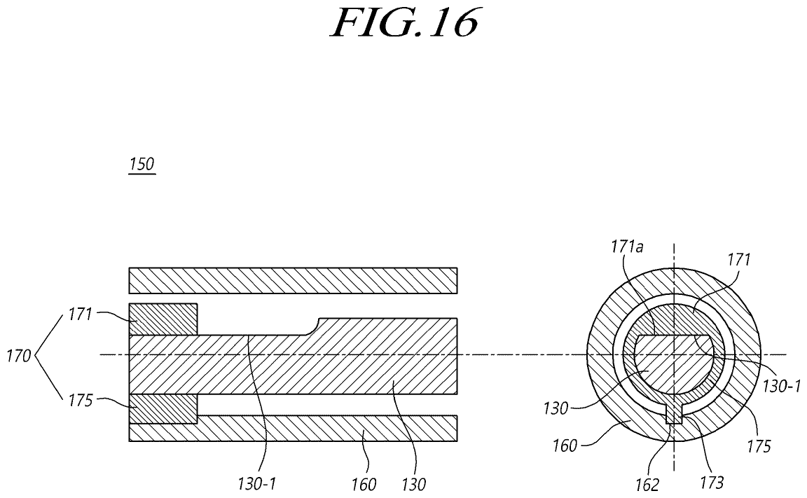

In an embodiment illustrated in FIG. 16, the rotation prevention member 150 may support the outer peripheral surface of the rack bar 130 to prevent the rack bar 130 from rotating about the central axis and the rotation prevention member 150 may be supported by the inner peripheral surface of the rack housing 160.

The rotation prevention member 150 may include a rack bushing 170 having a first support portion 171 and a second support portion 175. The first support portion 171 may be configured to support the support surface 130-1 formed on the outer peripheral surface of the rack bar 130. The second support portion 175 may be extended from or connected to the first support portion 171, may be configured to support the outer peripheral surface of the rack bar 130, and may have an outer peripheral surface on which a fixing protrusion 173, which is coupled to the housing groove 162 formed on the inner peripheral surface of the rack housing 160.

For example, the support surface 130-1 formed on a part of the outer peripheral surface of the rack bar 130 may be formed by machining or grinding the outer peripheral surface of the rack bar 130.

The support surface 130-1 may be recessed from the outer peripheral surface of the rack bar 130 and may have a curved surface or a flat surface.

The support surface 130-1 is elongated in the axial direction of the rack bar 130 so as to be supported by the first support portion 171 when the rack bar 130 slides in the axial direction.

An inner peripheral surface 171a of the first support portion 171 may be closely contacted with and supported by the support surface 130-1 of the rack bar 130, and an outer peripheral surface of the first support portion 171 may be spaced apart from the inner peripheral surface of the rack housing 160.

A coating layer may be provided on the support surface 130-1 and the outer peripheral surface of the rack bar 130 and made of a low-friction material, such as fluorine resin or ceramic, in order to minimize or reduce friction with the rack bushing 170.

The second support portion 175 is extended from or connected to the first support portion 171 in the circumferential direction and surrounds the outer peripheral surface of the rack bar 130.

The fixing protrusion 173 protrudes from the outer peripheral surface of the second support portion 175 in the radial direction.

The housing groove 162 may be formed on the inner peripheral surface of the rack housing 160, and the fixing protrusion 173 of the second support portion 175 may be inserted in or coupled to the housing groove 162, thereby preventing the rack bushing 170 from rotating.

For example, the housing groove 162 may be formed by machining or grinding the inner peripheral surface of the rack housing 160.

The housing groove 162 may be recessed from the inner peripheral surface of the rack housing 160 and may have a curved surface or a flat surface.

The rack bushing 170 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

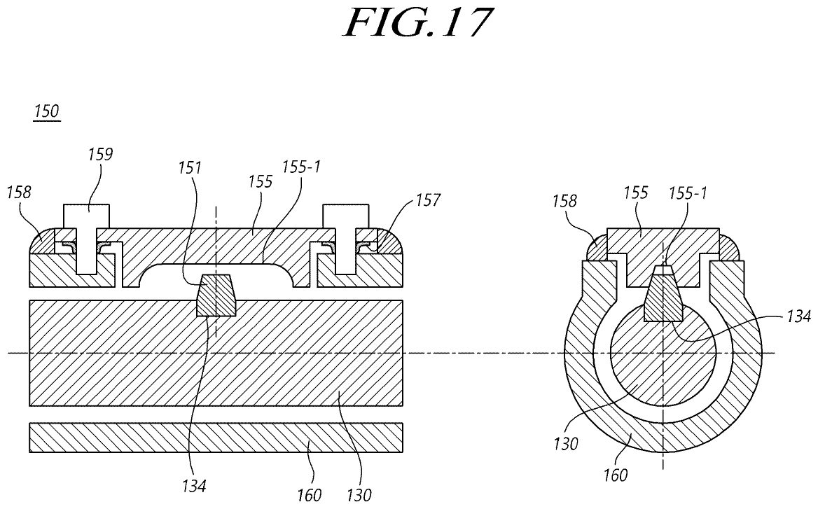

In an embodiment illustrated in FIG. 17, the rotation prevention member 150 may be supported by a guide cover 155, which is coupled to the rack housing 160, and may support the outer peripheral surface of the rack bar 130 to prevent the rack bar 130 from rotating about the central axis.

The rotation prevention member 150 may include a support member 151 coupled to the outer peripheral surface of the rack bar 130, the guide cover 155 coupled to the rack housing 160 and having an inner peripheral surface which the support member 151 supports, and a fastener 159 configured to fix the guide cover 155 to the rack housing 160.

The support member 151 may be coupled to the outer peripheral surface of the rack bar 130. For instance, the support member 151 may be coupled, by press-fitting, bonding, or the like, to a coupling groove 134 formed on the outer peripheral surface of the rack bar 130. The coupling groove 134 may be formed by machining or grinding the outer peripheral surface of the rack bar 130.

The coupling groove 134 may be recessed from the outer peripheral surface of the rack bar 130 and may have a curved surface or a flat surface.

The rack housing 160 may have an opening at a position facing or corresponding to the support member 151, and the guide cover 155 is coupled to and covers the opening of the rack housing 160.

The inner peripheral surface of the guide cover 155 may have a support groove 155-1 into and by which the support member 151 is inserted and supported.

The support groove 155-1 of the guide cover 155 is elongated in the axial direction of the rack bar 130 so that the support member 151 may be supported by the support groove 155-1 when the rack bar 130 slides in the axial direction.

The support groove 155-1 may have, for example, but not limited to, a trapezoidal shape having a width that increases toward the support member 151.

The support member 151 may have a trapezoidal shape having a width that decreases from the outer peripheral surface of the rack bar 130 toward the support groove 155-1.

Two opposite side surfaces of the support groove 155-1 may be closely contacted with and supported by the support member 151, and an inner top surface of the support groove 155-1 positioned between the two opposite side surfaces of the support groove 155-1 may be spaced apart from an end of the support member 151.

A coating layer may be provided on the support groove 155-1 or the support member 151 and made of a low-friction material, such as fluorine resin or ceramic, in order to reduce or minimize friction.

The support groove 155-1 may have grease therein in order to minimize friction with the support member 151.

The guide cover 155 may be fixed to the rack housing 160 by the fastener 159.

Further, an elastic member 157 may be disposed between the guide cover 155 and the rack housing 160, penetrated by the fastener 159, and configured to elastically support the guide cover 155 and the rack housing 160.

A sealing member or seal 158 may be applied onto the ends of the guide cover 155 and the outer peripheral surface of the rack housing 160 in order to prevent moisture or dust from being introduced from the outside of the rack housing 160.

The support member 151 and the guide cover 155 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

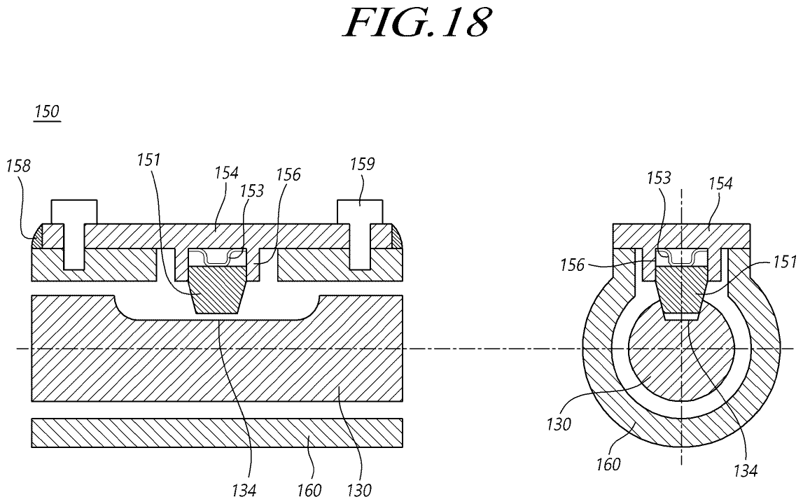

In an embodiment illustrated in FIG. 18, the rotation prevention member 150 may be supported by a housing cover 154, which is coupled to the rack housing 160, and the outer peripheral surface of the rack bar 130, thereby preventing the rack bar 130 from rotating about the central axis of the rack bar 130.

The rotation prevention member 150 may include the support member 151 supporting the outer peripheral surface of the rack bar 130, the housing cover 154 fixed to the rack housing 160 and having the inner peripheral surface to which the support member 151 is coupled, and the fastener 159 configured to fix the housing cover 154 to the rack housing 160.

A rack support groove 134 by which the support member 151 is supported is formed on the outer peripheral surface of the rack bar 130.

The rack support groove 134 is elongated or extended in the axial direction of the rack bar 130 so that the support member 151 may be supported by the rack support groove 134 when the rack bar 130 slides in the axial direction.

The rack support groove 134 may be recessed from the outer peripheral surface of the rack bar 130 and may have a curved surface or a flat surface.

The rack housing 160 may have an opening a position corresponding to or facing the rack support groove 134, and the housing cover 154 is coupled to the opening of the rack housing 160.

A cover support groove 156, in which the support member 151 is positioned, may be formed on the inner peripheral surface of the housing cover 154.

The rack support groove 134 may have, for example, but not limited to, a trapezoidal shape with a width that increases toward the housing cover 154.

The support member 151 may have a trapezoidal shape with a width that decreases from the cover support groove 156 toward the rack support groove 134.

Two opposite side surfaces of the rack support groove 134 may be closely contacted with and supported by the support member 151, and an inner surface of the rack support groove 134 positioned between the two opposite side surfaces of the rack support groove 134 may be spaced apart from the end of the support member 151.

A coating layer may be provided on the rack support groove 134 or the support member 151 and made of a low-friction material, such as fluorine resin or ceramic, in order to reduce or minimize friction.

The rack support groove 134 may be provided or filled with grease in order to reduce or minimize friction with the support member 151.

The housing cover 154 may be fixed to the rack housing 160 by the fastener 159.

The seal or sealing member 158 may be applied onto the end portion of the housing cover 154 and the outer peripheral surface of the rack housing 160 in order to prevent moisture or dust from being introduced from the outside of the rack housing 160.

The support member 151 and the housing cover 154 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

As described above, a steer-by-wire steering apparatus according to some embodiments of the present disclosure may have the plurality of motors and provide a steering force to a rack bar. In addition, a steer-by-wire steering apparatus according to some embodiments of the present disclosure may prevent unnecessary rotation of a rack bar even though means for preventing the rotation of the rack bar is provided and the pinion is excluded.

Hereinafter, various embodiments related to a method of determining the position of a rack bar in a steer-by-wire steering apparatus will be described. Some embodiments of the method of determining the position of the rack bar described below may be applied regardless of the above-mentioned configuration, position and shape of the motor. However, certain embodiments of the method of determining the position of the rack bar may be applied to the above-mentioned configuration, position and shape of the motor. In addition, the method of determining the position of the rack bar may be applied in exemplary embodiments of the steer-by-wire steering apparatus not including the rotation prevention member or may be applied in any type of a rotation prevention member.

In the steer-by-wire steering apparatus, the electronic control device 110 may control the operations of one or more drive motors (e.g., 145 and 147). For instance, the electronic control device 110 may receive information or one or more signals from one or more sensors associated with the vehicle and control one or more drive motors based on the information or signals received from one or more sensors.

One or more sensors include various sensors, such as a steering angle sensor, a steering torque sensor, a vehicle speed sensor, a rack position sensor, and any type of a sensor mounted to or provided in the vehicle in association with the steering of the vehicle. However, as described above, according to some embodiments of the present disclosure, the pinion may not be included in the steer-by-wire steering apparatus in case that the rack bar is configured to be moved by the first motor and the second motor. In this case, the rack position sensor configured to detect an absolute position of the rack bar may not be included in the steer-by-wire steering apparatus. Alternatively, the rack position sensor configured to detect the absolute position of the rack bar may be included in a gearbox configured to connect the first and/or second motors to the rack bar.

First, various embodiments for identifying the absolute position (or an absolute angle) of the rack bar will be described. Thereafter, an embodiment comprising an absolute angle sensor configured to detect the absolute position (or an absolute angle) of the rack bar will be described.

The electronic control device 110 may control an operation of the steering shaft motor 120. The electronic control device 110 may be configured as one chip integrated physically. Alternatively, the electronic control device 110 may be configured by a plurality of chips. For instance, each of a reaction force motor, a drive motor, a main control unit, and any component of the steer-by-wire steering apparatus includes one or more chips to perform their necessary operations.

Meanwhile, the electronic control device 110 may control a traveling direction of the vehicle in accordance with the driver's steering intention by controlling the operations of the plurality of drive motors (e.g., 145 and 147).

Multiple electronic control devices 110 may be provided in the steer-by-wire steering apparatus in order to ensure redundancy and constantly or stably perform the same operation even in a case that any one of the plurality of the electronic control devices 110 is abnormal or inoperable. Alternatively, the multiple electronic control devices 110 includes a main electronic control device and a sub-electronic control device. The main electronic control device may control the operation of the steer-by-wire steering apparatus if the main electronic control device is in a normal state, and the sub-electronic control device may control the operation of the steer-by-wire steering apparatus if the main electronic control device is abnormal or inoperable.

The electronic control device 110 may control the steering of the vehicle in response to various information. The steer-by-wire (SBW) system may need accurate information regarding a position of the rack bar to accurately control the steering of the vehicle especially in case that the plurality of motors is used to control the rack bar.

To this end, the electronic control device 110 may receive the position information of the rack bar from the rack position sensor. Alternatively, the electronic control device 110 may estimate the position of the rack bar by using positions of the plurality of motors without the rack position sensor.

For example, the electronic control device 110 may receive rotation information of each of the motors from the plurality of motor position sensors. In an exemplary embodiment of the present disclosure, the rotation information of the motor may include rotation information of the first motor and rotation information of the second motor. The rotation information of the first motor may be received from a first motor position sensor included in or associated with the first motor. The rotation information of the second motor may be received from a second motor position sensor included in or associated with the second motor.

The motor position sensor may detect rotation information of each of the motors. The motor position sensor may detect a rotation of a motor shaft. Alternatively, the motor position sensor may detect a rotation of any rotatable component or structure connected to or associated with the motor shaft. The motor position sensor may detect a rotary position between 0 degree and 360 degrees related to the rotation of the motor. For instance, the motor position sensor may measure a rotation angle and/or a position of the motor.

For example, the motor position sensor may be an optical sensor or encoder configured to detect a position by emitting light to a rotary plate or disk. Alternatively, the motor position sensor may be a magnetic sensor or encoder configured to measure a position of a rotor by detecting a magnetic field. Alternatively, the motor position sensor may be an incremental sensor or encoder configured to measure a change in a relative position of a rotor by outputting a predetermined pulse. Alternatively, the motor position sensor may be an absolute sensor or encoder configured to measure an absolute position of a rotor by outputting a unique value related to a particular position. The motor position sensor according to certain embodiments of the present disclosure may provide a precise position and/or velocity of the motor.

For instance, a Hall sensor, which measures a position of a motor by detecting a change in magnetic flux of a rotor to which a permanent magnet or magnetic material is attached or mounted, may be used as the motor position sensor. The motor of the steer-by-wire steering apparatus may be a Brushless Direct Current (BLDC) motor, and three Hall sensors having a phase difference of 120 degrees or 60 degrees may be arranged or disposed to detect the position of the motor. In addition, the motor position sensor may be a resolver configured to measure a position in an analog manner by using a change in voltage or an inductive position sensor configured to detect a position by using an electromagnetic induction principle. In the present disclosure, any type of sensors may be used as the motor position sensor.

The motor position sensor may measure an absolute position or an absolute angle value based on a particular position of the motor. Alternatively, the motor position sensor may detect a relative position with respect to a reference position. Alternatively, the motor position sensor may measure an electrical position of a rotor in a BLDC or Permanent Magnet Synchronous Motor (PMSM) motor.

A rotation angle in a single turn is a rotation angle between 0 degree and 360 degrees, and therefore a rotation angle can be represented in a single rotation turn only. Therefore, the absolute position of the motor which is over 360 degrees may not be identified because an angle of the rotor of the motor is reset after one full rotation turn. However, there is an absolute motor position sensor which can measure a position of the motor in multiple turns, but it has a complicated configuration and structure and a higher price.

Without using an absolute motor position sensor, some embodiments of the present disclosure may acquire an absolute position of the rack bar by using at least two motor position sensors which measure a relative position.

For example, when two motors move a same rack bar and have different rotational velocities, rotation angles measured by two motor position sensors of two motors, respectively, may be between 0 degree and 360 degrees. If the motor position sensor is not an absolute angle sensor, an angle measured by the motor position sensor is not recorded or stored, and a rotation angle detected by a motor position sensor of the first motor may be between 0 degree and 360 degrees and a rotation angle detected by a motor position sensor of the second motor may be between 0 degree and 360 degrees.

The electronic control device 110 may receive the rotation angle detected by the motor position sensor of the first motor and the rotation angle detected by the motor position sensor of the second motor. The electronic control device 110 estimates the absolute position of the rack bar by using two rotation angles (i.e., motor positions) detected by each of two motor positions sensors of two motors.

As described above, in certain embodiments of the present disclosure, the first motor and the second motor are operably connected to a single ball nut operably coupled to the rack bar and move the rack bar at different rotational velocities. Therefore, even though the first motor and the second motor rotate at different rotational velocities, the first motor and the second motor need to rotate the ball nut at the same velocity. Therefore, the motor pulley of the first motor and the motor pulley of the second motor may be configured by different in gear ratio.

The gear ratio may refer to, for example, but not limited to, a ratio of the numbers of threads or diameters of pulleys. For instance, the gear ratio may be a ratio between the number of threads or a diameter of a motor pulley connected to a motor shaft of the first motor and the number of threads or a diameter of a motor pulley connected to a motor shaft of the second motor. There may be a substantial difference in gear ratio in case that the diameters of the motor pulleys are different.

The first motor and the second motor may rotate at different rotational velocities, and the electronic control device 110 may receive different motor rotation information from the motor position sensors of the first and second motors.

The electronic control device 110 may determine the absolute position of the rack bar by using preset information and motor rotation information of the first and second motors.

For example, a difference in rotational velocity between the two motors may vary depending on the absolute position of the rack bar.

For example, the electronic control device 110 may determine the absolute position of the rack bar by monitoring a change in the rotation information of the two motors. For example, the electronic control device 110 may determine the position of the rack bar by using Equation 1.

$$R = \frac{K}{360} \times θ + K \times n \qquad [ Equation 1 ]$$

R represents a linear position of the rack bar, θ represents a phase difference between first rotation information of the first motor and second rotation information of the second motor, K represents a distance by which the rack bar is moved while a phase difference between the first rotation information and the second rotation information changes from 0 and a next phase difference becomes 0 in case that the rack bar moves in one direction, and n represents the number of times the phase difference becomes 0 while the rack bar moves in one direction.

That is, the electronic control device 110 may cumulatively identify the position of the rack bar by consistently monitoring the phase difference between the first rotation information of the first motor and the second rotation information of the second motor and recording the number of times the phase difference becomes 0.

In another example, the electronic control device 110 may determine the position of the rack bar based on a preset reference value. A movable range of the rack bar is structurally limited. Therefore, the plurality of positions of the rack bar corresponding to the first rotation information of the first motor and the second rotation information of the second motor can be calculated in advance and stored in the form of a table or other data formats in memory of the electronic control device 110.

When the first rotation information of the first motor and the second rotation information of the second motor are received, the electronic control device 110 may estimate the absolute position of the rack bar by comparing the first rotation information of the first motor and the second rotation information of the second motor with pre-stored data. However, in this case, the first rotation information and the second rotation information need to be designed to have different values in a linearly movable range of the rack bar. Therefore, a difference in gear ratio between the first motor and the second motor needs to be set so that the first rotation information of the first motor and the second rotation information of the second motor do not overlap at or correspond to two or more absolute positions of the rack bar.

For example, the electronic control device 110 may estimate the absolute position of the rack bar by using Equation 2.

$$A = \{ ( First Rotation Information + m ) \times First Gear Ratio \} \qquad [ Equation 2 ]$$

$$B = \{ ( Second Rotation Information + m ) \times Second Gear Ratio \}$$

$$Rack bar position R = intersection of A and B .$$

Here, m is a natural number equal to or larger than 1 and equal to or smaller than a maximum movable distance of the rack bar.

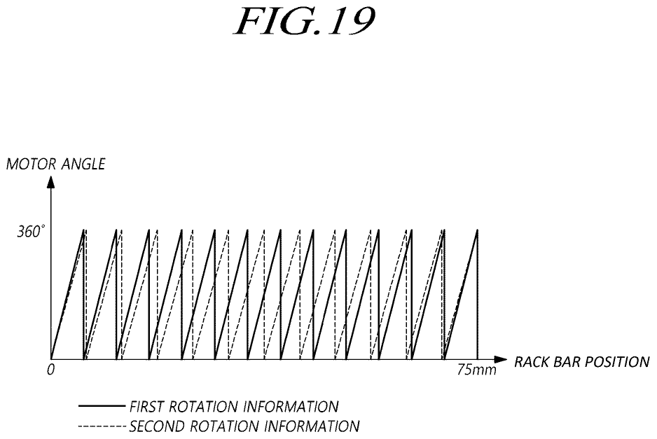

FIG. 19 is a graph for explaining a method of estimating a position of a rack bar using a difference between first rotation information of a first motor and second rotation information of a second motor. FIG. 19 illustrates relationship between the first rotation information of the first motor and the second rotation information of the second motor and a linear position of a rack bar in a movable range of the rack bar from 0 to 75 mm (or +/−85 mm). As described above, the first gear ratio and the second gear ratio may be set so that the first rotation information of the first motor and the second rotation information of the second motor do not overlap or correspond to multiple positions of the rack bar.

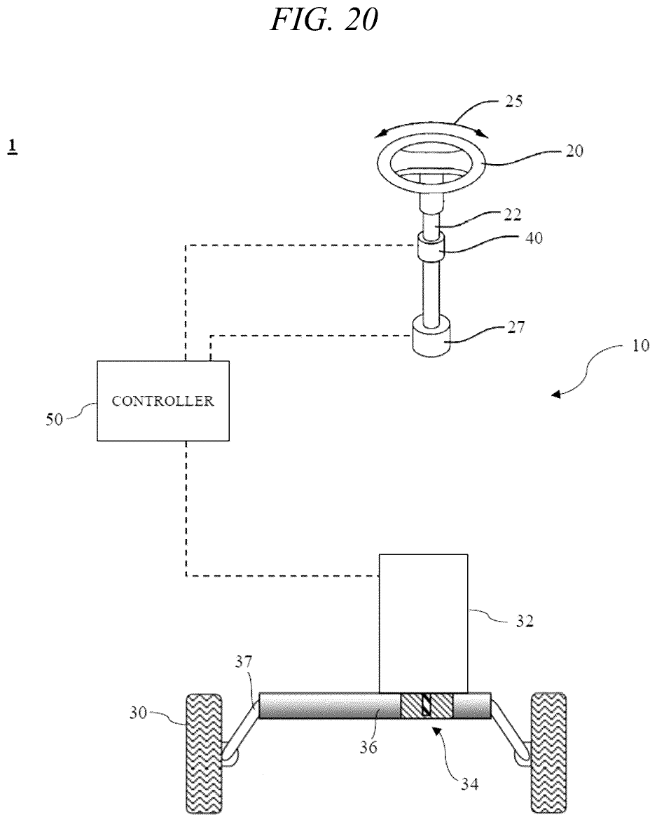

Referring now to FIG. 20, a steer-by-wire system 10 for use in a vehicle 1 according to an exemplary embodiment is illustrated. In a conventional automotive steering system such as an electric power steering (EPS) system, a steering wheel is mechanically linked to one or more road wheels (e.g. front road wheels). However, the steer-by-wire system 10 according to an embodiment of the present disclosure removes this mechanical connection and instead, electronically controls a steering angle of road wheels 30 based on measurement of a steering wheel or hand wheel 20 and/or one or more control signals of a controller 50 and provides feedback to a driver or operator of the vehicle 1 using a plurality of actuators such as electric motors. Further, in the steer-by-wire system 10, the steering angle of road wheels 30 can be controlled by one or more control signals generated by an autonomous driving system or an advanced driver assistance system (ADAS) and/or generated by the controller 50 based on data from one or more sensors.

The steer-by-wire system 10 allows the driver or operator of the vehicle 1 to control the direction of the vehicle 1 or road wheels 30 of the vehicle 1 through the manipulation of the steering wheel 20. The steering wheel 20 is operatively or mechanically coupled or fixed to a steering shaft (or steering column) 22. The steering wheel 20 may be directly or indirectly connected with the steering shaft 22. For example, the steering wheel 20 may be connected to the steering shaft 22 through a gear, a shaft, a belt and/or any connection means. Alternatively, the steering wheel 20 may be fixed to the steering shaft 22. The steering shaft 22 may rotate together with the steering wheel 20.

One or more steering wheel sensors 40 may be configured to detect position, angular displacement or travel 25 of the steering shaft 22 or steering wheel 20, as well as detect the torque of the angular displacement or travel 25 of the steering shaft 22 or steering wheel 20. The steering wheel sensor 40 provides electric signals to the controller 50 indicative of the angular displacement and/or torque 25. The controller 50 sends and/or receives signals to and/or from an upper actuator 27 (e.g., a steering feedback actuator having an electric motor) to actuate the upper actuator 27 in response to the angular displacement and/or torque 25 of the steering wheel 20. The upper actuator 27 rotates or moves the steering wheel 20 to provide feedback to the driver or operator (similarly to the feedback provided by the wheels in a manual steering vehicle) in response to the control signals received from the controller 50.

In the steer-by-wire system 10, the steering wheel 20 may be mechanically isolated from the road wheels 30. Accordingly, the steer-by wire steering system 10 needs to provide the driver or operator with the same “road feel” that the driver receives with a direct mechanical link. Furthermore, it is desirable to have a device that provides a mechanical back up “road feel” in the event of multiple electronic failures in the steer-by-wire system. In addition, a device that provides positive on-center feel and accurate torque variation as the handwheel is rotated is also desirable. Therefore, the vehicle 1 may comprise the upper actuator 27 (e.g. steering feedback actuator).

The upper actuator 27 may comprise, for example, but no limited to, an electric motor which is connected to the steering shaft or steering column 22. For example, a gear or belt assembly may connect an output of the upper actuator 27 to the steering shaft 22. Alternatively, the upper actuator 27 may be directly coupled to the steering shaft 22 or the hand wheel 20. The upper actuator 27 is actuatable to provide resistance to rotation of the steering wheel 20. The controller 50 is electrically coupled with the sensors 40 and to the upper actuator 27. The controller 50 receives signals indicative of the applied torque and angular rotation 25 of the steering wheel 20 from the sensors 40. In response to the signals from the sensors 40, the controller 50 generates and transmits a signal corresponding to the sensed torque and angular rotation of the steering wheel 20 sensed by the sensors 40 and the upper actuator 27 generates resistance torque to the rotation of the steering wheel 20 in response to the signal of the controller 50 to provide the steering feel to the driver.

The controller 50 also transmits signals or commands to a lower actuator 32 (e.g. a road wheel actuator). The lower actuator 32 controls the linear movement of a steering rack 36 in response to the control signals received form the controller 50. For example, the lower actuator 32 generates rotary motion in response to the control signals of the controller 50, and the rotary motion of the lower actuator 32 is converted into linear movement of the steering rack 36. Tie rods and knuckles 37 connect the steering rack 36 to road or vehicle wheels 30 and convert the linear movement of the steering rack 36 into rotation of the road wheels 30.

In use, the steering wheel 20 is angularly displaced 25 such that the steering shaft 22 can be also angularly displaced. The sensor 40 detects the angular displacement and torque 25 of the steering shaft 22 coupled with the steering wheel 20, and the sensor 40 sends signals to the controller 50 indicative of the relative amount of angular displacement and torque 25 of the steering shaft 22. The controller 50 sends control signals to the lower actuator 32 indicative of the relative amount of the angular displacement and/or toque of the steering shaft 22. In response, the lower actuator 32 moves the steering rack 36 so that the road wheels 30 are turned. Thus, the controller 50 controls the distance that the steering rack 36 is moved based on the amount of the angular displacement 25 of the steering wheel 20. Movement of the steering rack 36 manipulates the tie rods and knuckles 37 to reposition the road wheels 30 of the vehicle 1. Accordingly, when the steering wheel 20 is turned, the road wheels 30 are controlled to be turned.

In order to perform the prescribed functions and desired processing, as well as the computations therefore (e.g., the identification of motor parameters, control algorithm(s), and the like), the controller 50 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, the controller 50 may include input signal processing and filtering to enable accurate sampling and conversion or acquisitions of such signals from communications interfaces. Although FIG. 20 illustrates the controller 50 as a single controller, one skilled in the art would understand that the controller 50 may be distributed among a plurality of vehicle controllers such as a first circuit 320 of a first powerpack 300 and a second circuit 420 of a second powerpack 400.

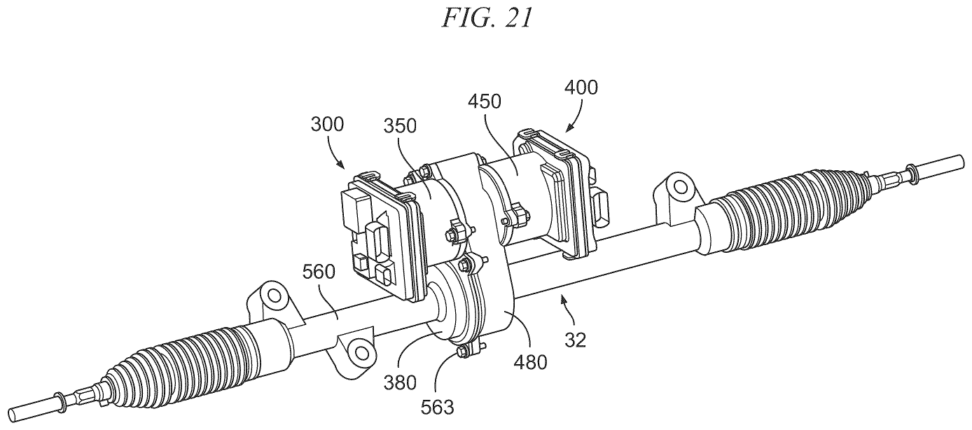

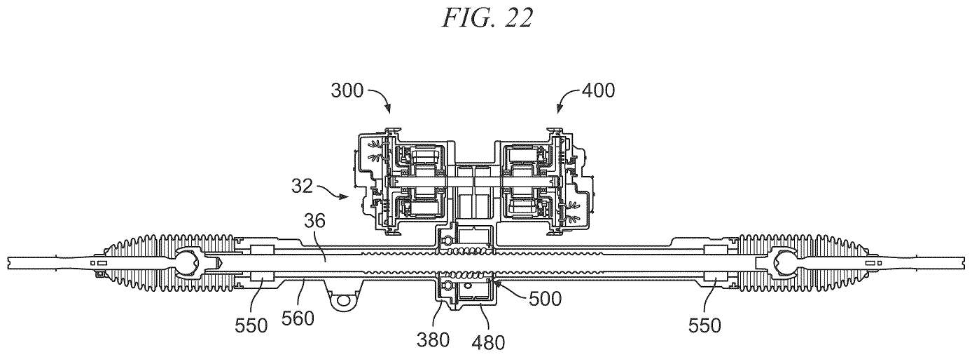

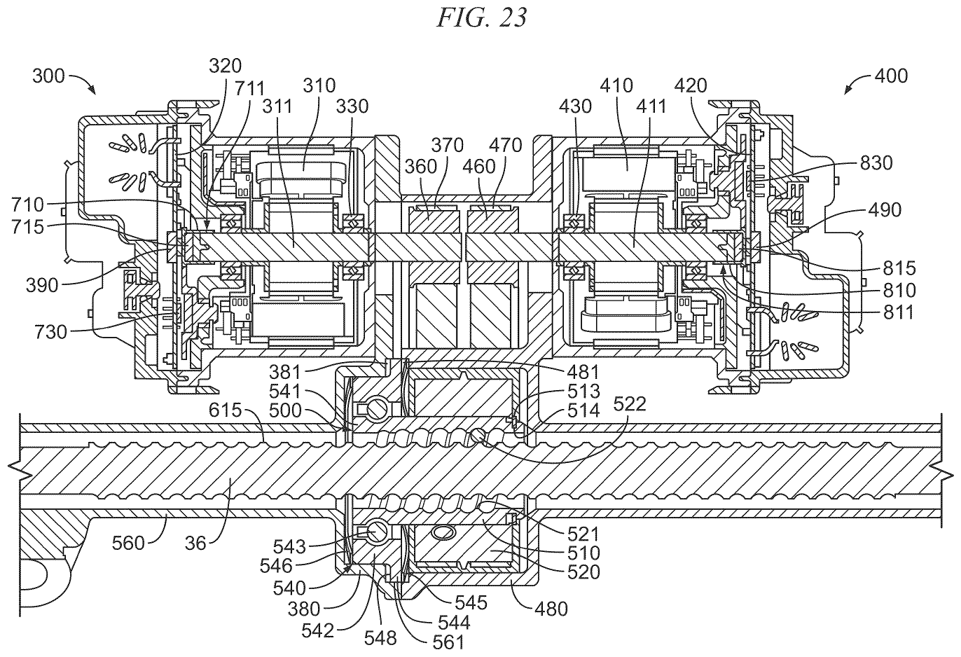

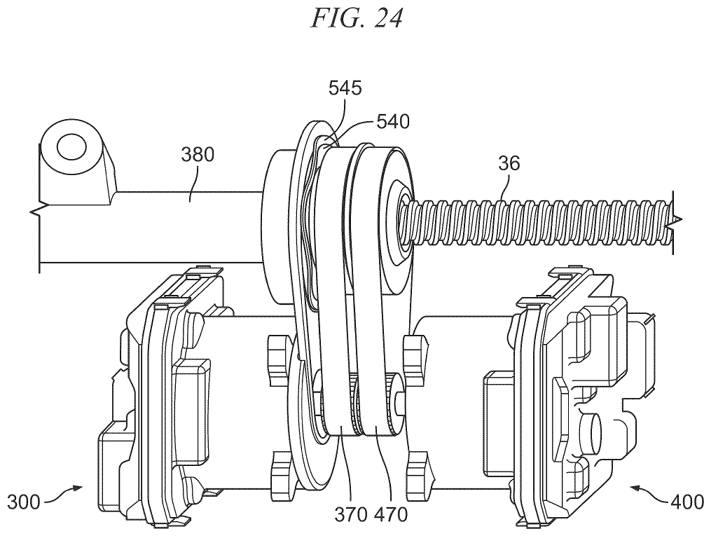

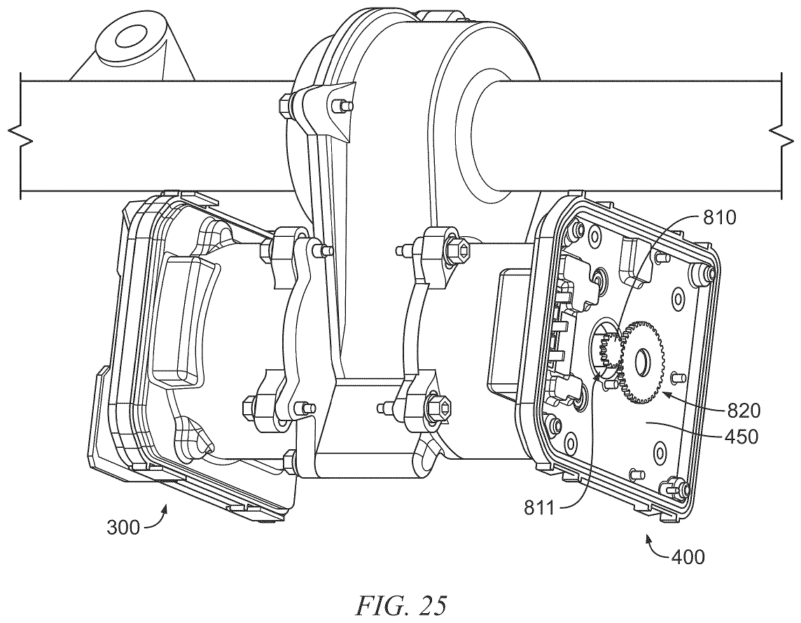

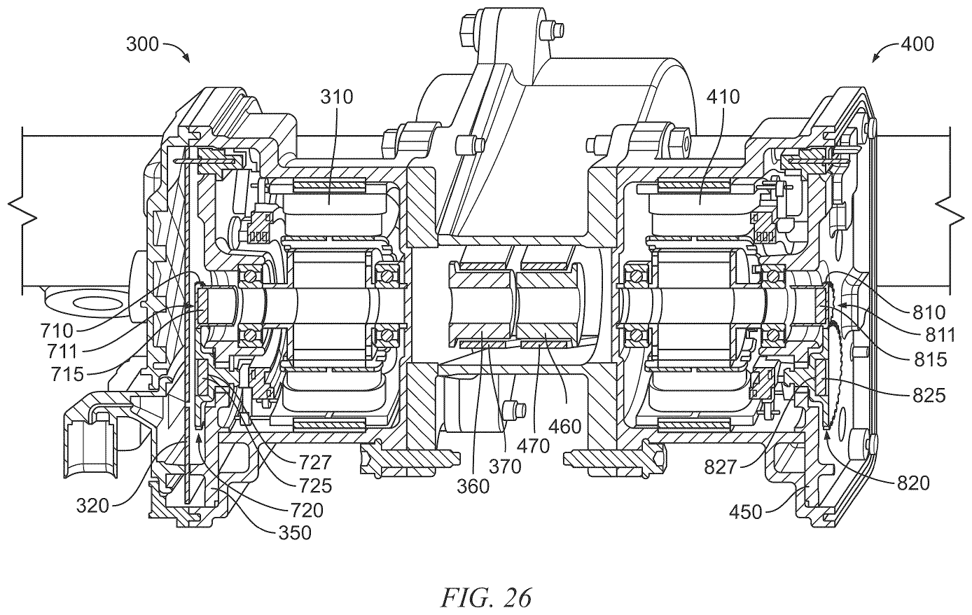

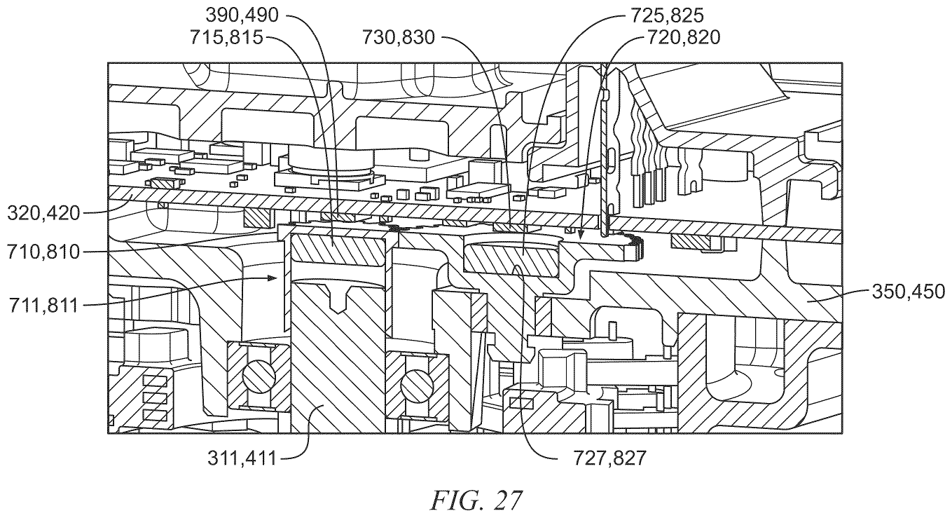

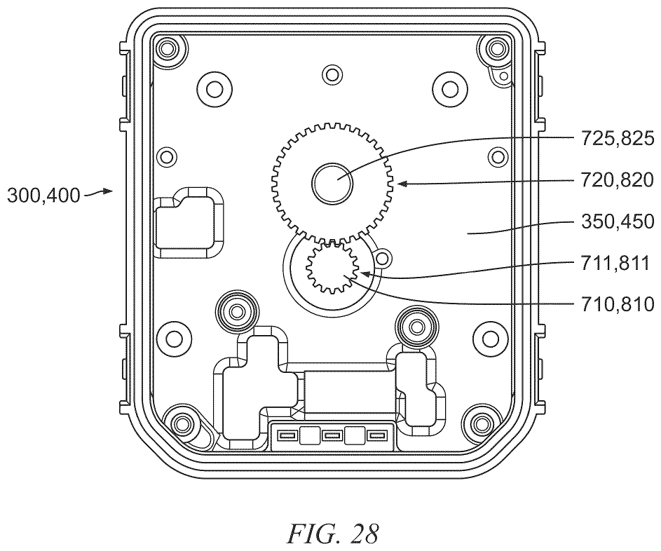

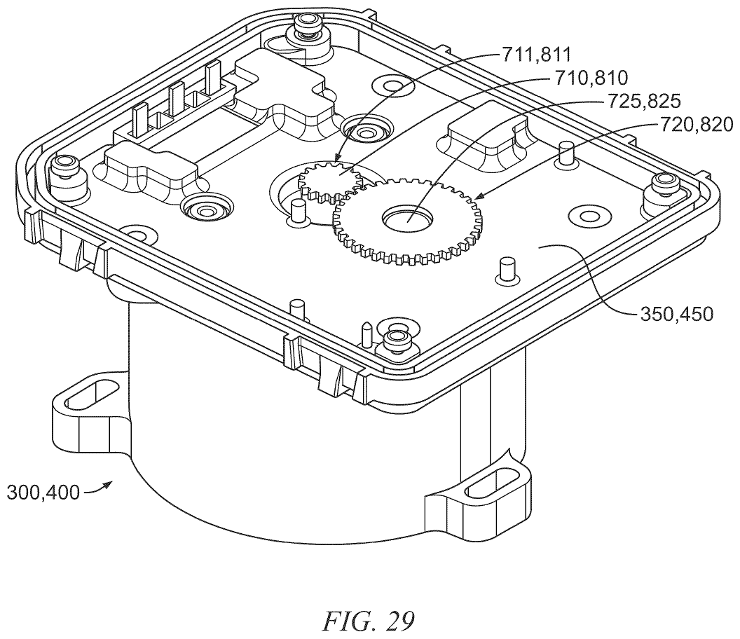

FIG. 21 is a perspective view for showing a steer-by-wire system according to an exemplary embodiment of the present disclosure. FIG. 22 is a cross-sectional view for illustrating a steer-by-wire system according to an exemplary embodiment of the present disclosure. FIG. 23 is a partial cross-sectional view for illustrating a steer-by-wire system according to an exemplary embodiment of the present disclosure. FIG. 22 is a cross-sectional view for illustrating a steer-by-wire system according to an exemplary embodiment of the present disclosure. FIG. 23 is a partial cross-sectional view for illustrating a steer-by-wire system according to an exemplary embodiment of the present disclosure. FIGS. 24-25 are a partial perspective view for illustrating a steer-by-wire system according to an exemplary embodiment of the present disclosure. FIGS. 26-27 is partial cross-sectional views for illustrating a steer-by-wire system according to an exemplary embodiment of the present disclosure. FIG. 28 is a partial plan view for illustrating a steer-by-wire system according to an exemplary embodiment of the present disclosure. FIG. 29 is a partial perspective view for illustrating a steer-by-wire system according to an exemplary embodiment of the present disclosure.

The lower actuator 32 (e.g. a road wheel actuator) may comprise a first power pack 300 and a second power pack 400.

The first powerpack 300 may comprise a first motor 310 having a first motor shaft 311, a first circuit 320, and a first sealed bearing 330. The second powerpack 400 may comprise a second motor 410 having a second motor shaft 411, a second circuit 420, and a second sealed bearing 430.

The first and second circuits 320 and 420 may comprise any suitable circuitry and electronic components, such as a microprocessor, a processor, a computer, and/or memory, mounted thereon. The first and second circuits 320 and 420 may be configured to control the first and second motors 310 and 320, for example, but not limited to, supply power to the first and second motors 310 and 320, activate or deactivate the operation of the first and second motors 310 and 320, and vary the speed of the first and second motors 310 and 320 and/or the rotational direction of the first and second motors 310 and 320.

The first or second sealed bearing 330 or 430 supports the first or second motor shaft 311 or 411 so that the first or second motor shaft 311 or 411 can be rotatably supported by the first or second sealed bearing 330 or 430 to rotate smoothly. The first or second sealed bearing 330 or 430 may have one or more sealing shields or protective barriers mounted on the sides of the bearing to protect against external contamination such as dirt, sand, and water. For example, the first or second sealed bearing 330 and 430 may be located around the hole of the first or second powerpack housing 350 or 450 through which the first or second motor shaft 311 or 411 passes, and therefore the first or second sealed bearing 330 or 430 can prevent external contaminants like dust, moisture, and debris from entering the first or second powerpack housing 350 or 450. The first or second sealed bearing 330 or 430 may prevent common point of external contaminant intrusion from within a gear cavity to the first or second powerpack 300 or 400. Because the first or second sealed bearing 330 or 430 has integral seals therein, less space may be required in the first or second powerpack 300 or 400 and production efficiency may be improved.

A first drive pulley 360 may be provided on the first motor shaft 311. For example, the first drive pulley 360 may be formed directly on the first motor shaft 311 or attached to the first motor shaft 311. The first drive pulley 360 may have an outer surface that engages an inner surface of a first drive belt 370. The first drive pulley 360 of the first powerpack 300 is rotatably connected to a rotary-to-linear conversion mechanism 500 via the first drive belt 370. For instance, the first drive belt 370 connects the first drive pulley 360 of the first powerpack 300 to a driven pulley 520 of the rotary-to-linear conversion mechanism 500. The first motor 310 may provide a rotary torque to the first drive pulley 360 via the first motor shaft 311. The rotation force of the first drive pulley 360 is transferred to the first drive belt 370. As the rotation force is applied to the first drive belt 370, the rotational force of the first motor 310 of the first powerpack 300 is transferred to the rotary-to-linear conversion mechanism 500.

A second drive pulley 460 may be provided on the second motor shaft 411. For example, the second drive pulley 460 may be formed directly on the second motor shaft 411 or attached to the second motor shaft 411. The second drive pulley 460 may have an outer surface that engages an inner surface of a second drive belt 470. The second drive pulley 460 of the second powerpack 400 is rotatably connected to the rotary-to-linear conversion mechanism 500 via the second drive belt 470. For instance, the second drive belt 470 operably connects the second drive pulley 460 of the second powerpack 400 to the driven pulley 520 of the rotary-to-linear conversion mechanism 500. The second motor 410 may provide a rotary torque to the second drive pulley 460 via the second motor shaft 411. The rotation force of the second drive pulley 460 is transferred to the second drive belt 470. As the rotation force is applied to the second drive belt 470, the rotational force of the second motor 410 of the second powerpack 400 is transferred to the rotary-to-linear conversion mechanism 500.

The rotary-to-linear conversion mechanism 500 (such as a nut-screw mechanism and a ball nut-screw mechanism) may be configured to convert rotary motion transferred from the first motor 300 and/or the second motor 400 through the first drive belt 310 and/or the second drive belt 410 into linear motion in order to linearly move the steering rack 36. The rotary-to-linear conversion mechanism 500 may include a rotatable cylinder part 510.

The rotatable cylinder part 510 may comprise a nut or a ball nut. At least a part of the steering rack 36 is retained within or surrounded by the rotatable cylinder part 510. The rotatable cylinder part 510 has an internally-threaded track groove 521 on the inner surface of the rotatable cylinder part 510, and at least a part of the steering rack 32 has an externally-threaded track groove 615 for a rotatable body arrangement of rotatable bodies 522 (e.g. balls). The rotatable bodies 522 are disposed between the internally-threaded track groove 521 of the rotatable cylinder part 510 and the externally-threaded track groove 615 of the steering rack 36. The rotatable bodies 522 may be metal spheres which decrease friction and transfer loads between adjacent components. The rotatable cylinder part 510 is rotatably supported by the steering rack 36 via the rotatable bodies 522 and a bearing 540. However, in alternative embodiments of the present disclosure, the internally-threaded track groove 521 of the rotatable cylinder part 510 and the externally-threaded track groove 615 of the steering rack 36 can be directly engaged with each other without the rotatable bodies 522. The driven pulley 520 may be formed directly on the rotatable cylinder 510 or attached to the rotatable cylinder 510.

The bearing 540 may support the rotatable cylinder part 510 of the rotary-to-linear conversion mechanism 500 so that the bearing 540 can support the rotary motion of the rotatable cylinder part 510. For example, the bearing 540 may be, for instant, but not limited to, a four-point bearing. The bearing 540 may be positioned between the rotary-to-linear conversion mechanism 500 and a non-rotating structure, for example, but not limited to, a first housing part 380 or a second housing part 480. The bearing 540 is used to rotatably support the rotatable cylinder part 510 for rotation relative to the non-rotating structure.

An inner race 541 of the bearing 540 may be integrated with the rotatable cylinder part 510 as a single piece such that the inner race 541 of the bearing 540 and the nut or ball nut of the rotary-to-linear conversion mechanism 500 are integrated to form a single cylinder part, thereby providing a simpler assembly process and reducing manufacturing cost. For example, the inner race 541 of the bearing 540 may integrally formed on the outer surface of the rotatable cylinder part 510. Alternatively, the inner race 541 may be mounted to the outer surface of the rotatable cylinder part 510 as a separate piece from the rotatable cylinder part 510.

The bearing 540 may comprise an outer race (or an outer ring) 542. The outer race 542 may be located concentrically about the inner race 541, with the rollable bodies 543 therebetween, in a plane generally perpendicular to a rotatable axis of the rotatable cylinder part 510 or the inner race 541 or a translatable axis of the rack bar 36. The inner race 541 is rotatable, but the outer race 542 is substantially non-rotatable.

A rack housing 560 accommodates at least a portion of the steering rack 36, the rotatable cylinder part 510, and the bearing 540. The rack housing 560 has a groove 561 recessed from the inner surface of the rack housing 560. The outer race or outer ring 542 of the bearing 540 has a flanged part 544 protruding from the outer surface of the outer race or outer ring 542 in a radial direction. The flanged part 544 of the outer race 542 has a larger outer diameter than the other part of the outer race 542. The flanged part 544 of the outer race 542 of the bearing 540 is disposed in the groove 561 of the rack housing 560 so that the outer race or outer ring 542 of the bearing 540 can be properly fixed in the rack housing 560. By having the flanged part 544 of the outer race or outer ring 542 of the bearing 540, the bearing 540 can be securely retained in the rack housing 560 without an additional retainer for the bearing 540 such as a locking ring.

The rack housing 560 may consist of multiple pieces. For instance, the rack housing 560 comprises the first housing part 380 and the second housing part 480. A first groove portion 381 of the groove 561 may be formed at an end portion of the first housing part 380 and a second groove portion 481 of the groove 561 may be formed at an end portion of the second housing part 480 so that the first groove portion 381 of the first housing part 380 and the second groove portion 481 of the second housing part 480 can form the groove 561 in which the flanged part 544 of the outer race 542 of the bearing 540 is inserted. By this configuration, the process for assembling the bearing 540 and a first support 545 into the rack housing 560 may be simplified. One or more fasteners 563 such as a bolt may affix the first housing part 380 and the second housing part 480 to each other.

At least a part of the first support 545, along with the flanged part 544 of the outer race or outer ring 542 of the bearing 540, may be located in the groove 561 of the rack housing 560. The first support 545 may elastically support the flanged part 544 of the outer race or outer ring 542 of the bearing 540. As illustrated in FIGS. 23 and 24, the first support 545 is located on a side of the flanged part 544 facing the driven pulley 520. Alternatively, the first support 545 or additional support may be located on the other side 548 of the flanged part 544.

While the first support 545 is disposed on one side of the outer race or outer ring 542 of the bearing 540 where the flanged part 544 is formed, a second support 546 may be located on the opposite side of the outer race or outer ring 542 of the bearing 540 so that the second support 546 may elastically support the opposite side of the outer race or outer ring 542.

The first and second supports 545 and 546 can prevent rattle and cladder which may be caused by the movement of the outer race or outer ring 542 of the bearing 540. The rack housing 560 may include either one or both of the first support 545 and the second support 546.

A third support 513 may support a side of the driven pulley 520 and be disposed in a groove 514 recessed from an outer surface of the rotatable cylinder part 510.

The first, second, and third supports 545, 546, and 513 may include elastic material and have a ring shape such as a wavy ring. For example, the first, second, and third supports 545, 546, and 513 may be a rubber ring, a spring, or a circular metal component with a wavy or corrugated shape (e.g. a wavy spring or a wavy washer). However, any material or shape can be used if the first, second, and third supports 545, 546, and 513 can appropriately support the flanged part 544 or other part of the outer race or outer ring 542 or the driven pulley 520.

The first drive belt 370 operably coupled to the first motor 310 of the first powerpack 300 is rotatably coupled to one portion of the driven pulley 520, and the second drive belt 470 operably coupled to the second motor 410 of the second powerpack 400 is rotatably coupled to the other portion of the driven pulley 520. The outer diameter of the one portion of the driven pulley 520 to which the first drive belt 370 is coupled and the outer diameter of the other portion of the driven pulley 520 to which the second drive belt 470 is coupled may be the same as each other. However, the outer diameter of the one portion of the driven pulley 520 to which the first drive belt 370 is coupled may be different from the outer diameter of the other portion of the driven pulley 520 to which the second drive belt 470 is coupled if necessary for identify the linear position of the steering rack 36 using the Vernier algorithm. Further, the number of teeth of one portion of the driven pulley 520 provided on the rotatable part 510 of the rotary-to-linear conversion mechanism 500 and operably coupled to the first motor 310 of the first powerpack 300 and the number of teeth of another portion of the driven pulley 520 provided on the rotatable part 510 of the rotary-to-linear conversion mechanism 500 and operably coupled to the second motor 410 of the second powerpack 400 are identical to each other. However, the number of teeth of one portion of the driven pulley 520 provided on the rotatable part 510 of the rotary-to-linear conversion mechanism 500 and operably coupled to the first motor 310 of the first powerpack 300 may be different from the number of teeth of another portion of the driven pulley 520 provided on the rotatable part 510 of the rotary-to-linear conversion mechanism 500 and operably coupled to the second motor 410 of the second powerpack 400 if necessary for identify the linear position of the steering rack 36 using the Vernier algorithm.

A flange protruding from the outer surface of the driven pulley 520 of the rotary-to-linear conversion mechanism 500 may be located between the first drive belt 370 and the second drive belt 470 such that the first drive belt 370 and the second drive belt 470 are positioned to be spaced apart from each other in order to maintain the first drive belt 370 and the second drive belt 470 in place and prevent from interfering each other.

Both the first drive pulley 360 of the first powerpack 300 and the second drive pulley 460 of the second powerpack 400 are rotatably connected to one driven pulley 520 of the rotary-to-linear conversion mechanism 500 via the first drive belt 370 and the second drive belt 470, respectively. The configuration of the belts 370 and 470 allows an inner engagement surface of the belts 370 and 470 to wrap around and engage both the first and second drive pulleys 360 and 460 of the first and second powerpacks 300 and 400 and the driven pulley 520 that is fixed to the rotatable part 510 of the rotary-to-linear conversion mechanism 500. The rotational movement of at least one of the first drive pulley 360 of the first powerpack 300 and the second drive pulley 460 of the second powerpack 400 causes rotation of the driven pulley 520 and the rotatable part 510 of the rotary-to-linear conversion mechanism 500, and then the rotary motion of the rotatable part 510 of the rotary-to-linear conversion mechanism 500 is converted into the linear motion of the steering rack 36 by the rotary-to-linear conversion mechanism 500.

A first motor position sensor 390 is responsive to the rotation of the first motor shaft 311. The first motor position sensor 390 may be disposed in sensing relationship with the first motor shaft 311. For example, the first motor position sensor 390 may be positioned adjacent or around an end of the first motor shaft 311. The first motor position sensor 390 can detect or sense an angular position of the first motor 310 (such as an angular position of a first drive gear 710 or an angular position of the first motor shaft 311) in a single-turn range which is a range of zero to three hundred sixty degrees (0-360°). The first motor position sensor 390 may generate output signals indicative of the sensed angular positions of the first motor shaft 311. The first motor position sensor 390 is mounted on and electrically connected with the first circuit board 320.

A second motor position sensor 490 is responsive to the rotation of the second motor shaft 411. The second motor position sensor 490 may be disposed in sensing relationship with the second motor shaft 411. For example, the second motor position sensor 490 may be positioned adjacent or around an end of the second motor shaft 411. The second motor position sensor 490 can detect or sense an angular position of the second motor 410 (such as an angular position of a second drive gear 810 or an angular position of the second motor shaft 411) in a single-turn range which is a range of zero to three hundred sixty degrees (0-360°). The second motor position sensor 490 may generate output signals indicative of the sensed angular positions of the second motor shaft 411. The second motor position sensor 490 is mounted on and electrically connected with the second circuit board 420.

The first motor position sensor 390 can be any suitable device(s) for generating signal responsive to the rotation of the first motor shaft 311. For example, the first motor position sensor 390 may be an inductive sensor, a magnetic sensor (e.g. a Hall effect sensor), a magnetoresisitve (MR) sensor, or any other sensor known in the art with similar capabilities.

In one embodiment, the first motor position sensor 390 may be a magnetic type sensor (e.g., a Hall effect sensor). The first motor shaft 311 may comprise a magnetic material such as a permanent magnet. For instance, a first magnet 715 may be mounted on an end of the first motor shaft 311. The first motor shaft 311 has a first shaft cover 711 covering an end of the first motor shaft 311, and the first magnet 715 may be disposed within an inside space of the first shaft cover 711 or coupled to the first shaft cover 711. In another example, a magnetic gradient is formed on a surface of the first motor shaft 311 and defined by a plurality of alternating north and south magnetically charged elements circumferentially spaced about the circumference of the first motor shaft 311. The magnet field between the magnetic material of the first motor shaft 311 and the first motor position sensor 390 can be varied as a function of the angular displacement of the first motor shaft 311. The first motor position sensor 390 may sense or detect the magnetic field around the first motor shaft 311 to identify an angular position of the first motor 310.

In another embodiment, the first motor position sensor 390 may be an inductive type sensor. The inductive type sensor may be a sensor configured to operate based on the principle of electromagnetic induction to detect or measure nearby metallic objects. An inductor develops a magnetic field when an electric current flows through it. Alternatively, a current will flow through a circuit containing an inductor when the magnetic field through it changes. This effect can be used to detect metallic objects that interact with a magnetic field. For example, the inductive type sensor according to an embodiment of the present disclosure may utilize aspects described in U.S. patent application Ser. No. 18/930,897, entitled “INDUCTIVE SENSOR SYSTEM COMPRISING INDUCTIVE TORQUE AND POSITION SENSOR ASSEMBLIES”, filed on Oct. 29, 2024, which is hereby incorporated herein by reference in its entirety. In an embodiment for the inductive type sensor, an excitation or transmitter coil set configured to generate an electromagnetic field over the first motor shaft 311 and a receiver coil set configured to detect the electromagnetic field around the first motor shaft 311 may be included in or mounted to the first circuit board 320, and metallic material such as a target having a metallic pattern or one or more conductive loops configured to affect the electromagnetic field generated by the excitation or transmitter coil set may be included in or attached to the first motor shaft 311 instead of the first magnet 715. The inductive type sensor may reduce the size of the first powerpack 300 and lower manufacturing cost of the steer-by-wire system 10.

The first motor shaft 311 has a first drive gear 710. The first drive gear 710 may may be attached to the first motor shaft 311 or directly formed on the outer surface of the first motor shaft 311 as a toothed portion. For instance, as shown in FIGS. 26 and 27, the first drive gear 710 may be directly formed on or attached to an outer surface of the first shaft cover 711. When the first motor shaft 311 rotates, the first drive gear 710 rotates together.

A first driven gear 720 may be rotatably engaged with the first drive gear 710 of the first motor shaft 311. When the first motor shaft 311 rotates, the first drive gear 710 of the first motor shaft 311 drives the first driven gear 720 to rotate. The first driven gear 720 may be rotatably mounted to the inner surface of the first powerpack housing 350.

A diameter of the first driven gear 720 or the number of gear teeth of the first driven gear 720 is greater than a diameter of the first drive gear 710 or the number of gear teeth of the first drive gear 710 in order to precisely identify the angular position of the first driven gear 720 and easily make the gear ratios associated with the first and second driven gears 710 and 810 different.

A first gear position sensor 730 is responsive to the rotation of the first driven gear 720. The first gear position sensor 730 may be disposed in sensing relationship with the first driven gear 720. For example, the first gear position sensor 730 may be positioned adjacent or around the first driven gear 720. The first gear position sensor 730 can detect or sense an angular position of the first driven gear 720 in a single-turn range which is a range of zero to three hundred sixty degrees (0-360°). The first gear position sensor 730 may generate output signals indicative of the sensed angular positions of the first driven gear 720. The first gear position sensor 730 is mounted on and electrically connected with the first circuit board 320.

The first gear position sensor 730 can be any suitable device(s) for generating signal responsive to the rotation of the first driven gear 720. For example, the first gear position sensor 730 may be an inductive sensor, a magnetic sensor (e.g. a Hall effect sensor), a magnetoresisitve (MR) sensor, or any other sensor known in the art with similar capabilities.

In one embodiment, the first gear position sensor 730 may be a magnetic type sensor (e.g., a Hall effect sensor). The first driven gear 720 may comprise a magnetic material such as a permanent magnet. For instance, a third magnet 725 may be coupled to the first driven gear 720. As illustrated in FIG. 27, the first driven gear 720 may have a first groove 727 formed on a surface of the first driven gear 720 facing the first gear position sensor 730 so that the third magnet 725 can be disposed in the first groove 727 of the first driven gear 720. In another example, a magnetic gradient may be formed on a surface of the first driven gear 720 and defined by a plurality of alternating north and south magnetically charged elements circumferentially spaced about the circumference of the first driven gear 720. The magnet field between the magnetic material of the first driven gear 720 and the first gear position sensor 730 can be varied as a function of the angular displacement of the first driven gear 720. The first gear position sensor 730 may sense or detect the magnetic field around the first driven gear 720 to identify an angular position of the first driven gear 720.

In another embodiment, the first gear position sensor 730 may be an inductive type sensor. The inductive type sensor may be a sensor configured to operate based on the principle of electromagnetic induction to detect or measure nearby metallic objects. An inductor develops a magnetic field when an electric current flows through it. Alternatively, a current will flow through a circuit containing an inductor when the magnetic field through it changes. This effect can be used to detect metallic objects that interact with a magnetic field. For example, the inductive type sensor according to an embodiment of the present disclosure may utilize aspects described in U.S. patent application Ser. No. 18/930,897, entitled “INDUCTIVE SENSOR SYSTEM COMPRISING INDUCTIVE TORQUE AND POSITION SENSOR ASSEMBLIES”, filed on Oct. 29, 2024, which is hereby incorporated herein by reference in its entirety. In an embodiment for the inductive type sensor, an excitation or transmitter coil set configured to generate an electromagnetic field over the first driven gear 720 and a receiver coil set configured to detect the electromagnetic field around the first driven gear 720 may be included in or mounted to the first circuit board 320, and metallic material such as a target having a metallic pattern or one or more conductive loops configured to affect the electromagnetic field generated by the excitation or transmitter coil set may be included in or attached to the first driven gear 720 instead of the third magnet 725. The inductive type sensor may reduce the size of the first powerpack 300 and lower manufacturing cost of the steer-by-wire system 10.

The second motor position sensor 490 can be any suitable device(s) for generating signal responsive to the rotation of the second motor shaft 411. For example, the second motor position sensor 490 may be an inductive sensor, a magnetic sensor (e.g. a Hall effect sensor), a magnetoresisitve (MR) sensor, or any other sensor known in the art with similar capabilities.

In one embodiment, the second motor position sensor 490 may be a magnetic type sensor (e.g., a Hall effect sensor). The second motor shaft 411 may comprise a magnetic material such as a permanent magnet. For instance, a second magnet 815 may be mounted on an end of the second motor shaft 411. The second motor shaft 411 has a second shaft cover 811 covering an end of the second motor shaft 411, and the second magnet 815 may be disposed within an inside space of the second shaft cover 811 or coupled to the second shaft cover 811. In another example, a magnetic gradient is formed on a surface of the second motor shaft 411 and defined by a plurality of alternating north and south magnetically charged elements circumferentially spaced about the circumference of the second motor shaft 411. The magnet field between the magnetic material of the second motor shaft 411 and the second motor position sensor 490 can be varied as a function of the angular displacement of the second motor shaft 411. The second motor position sensor 490 may sense or detect the magnetic field around the second motor shaft 411 to identify an angular position of the second motor 410.

In another embodiment, the second motor position sensor 490 may be an inductive type sensor. The inductive type sensor may be a sensor configured to operate based on the principle of electromagnetic induction to detect or measure nearby metallic objects. An inductor develops a magnetic field when an electric current flows through it. Alternatively, a current will flow through a circuit containing an inductor when the magnetic field through it changes. This effect can be used to detect metallic objects that interact with a magnetic field. For example, the inductive type sensor according to an embodiment of the present disclosure may utilize aspects described in U.S. patent application Ser. No. 18/930,897, entitled “INDUCTIVE SENSOR SYSTEM COMPRISING INDUCTIVE TORQUE AND POSITION SENSOR ASSEMBLIES”, filed on Oct. 29, 2024, which is hereby incorporated herein by reference in its entirety. In an embodiment for the inductive type sensor, an excitation or transmitter coil set configured to generate an electromagnetic field over the second motor shaft 411 and a receiver coil set configured to detect the electromagnetic field around the second motor shaft 411 may be included in or mounted to the second circuit board 420, and metallic material such as a target having a metallic pattern or one or more conductive loops configured to affect the electromagnetic field generated by the excitation or transmitter coil set may be included in or attached to the second motor shaft 411 instead of the second magnet 415. The inductive type sensor may reduce the size of the second powerpack 400 and lower manufacturing cost of the steer-by-wire system 10.

The second motor shaft 411 has a second drive gear 810. The second drive gear 810 may may be attached to the second motor shaft 411 or directly formed on the outer surface of the second motor shaft 411 as a toothed portion. For instance, as shown in FIGS. 26 and 27, the second drive gear 810 may be directly formed on or attached to an outer surface of the second shaft cover 811. When the second motor shaft 411 rotates, the second drive gear 810 rotates together.

A second driven gear 820 may be rotatably engaged with the second drive gear 810 of the second motor shaft 411. When the second motor shaft 411 rotates, the second drive gear 810 of the second motor shaft 411 drives the second driven gear 820 to rotate. The second driven gear 820 may be rotatably mounted to the inner surface of the second powerpack housing 450.

A diameter of the second driven gear 820 or the number of gear teeth of the second driven gear 820 is greater than a diameter of the second drive gear 810 or the number of gear teeth of the second drive gear 810 in order to precisely identify the angular position of the second driven gear 820 and easily make the gear ratios associated with the first and second driven gears 710 and 810 different.

A second gear position sensor 830 is responsive to the rotation of the second driven gear 820. The second gear position sensor 830 may be disposed in sensing relationship with the second driven gear 820. For example, the second gear position sensor 830 may be positioned adjacent or around the second driven gear 820. The second gear position sensor 830 can detect or sense an angular position of the second driven gear 820 in a single-turn range which is a range of zero to three hundred sixty degrees (0-360°). The second gear position sensor 830 may generate output signals indicative of the sensed angular positions of the second driven gear 820. The second gear position sensor 830 is mounted on and electrically connected with the second circuit board 420.

The second gear position sensor 830 can be any suitable device(s) for generating signal responsive to the rotation of the second driven gear 820. For example, the second gear position sensor 830 may be an inductive sensor, a magnetic sensor (e.g. a Hall effect sensor), a magnetoresisitve (MR) sensor, or any other sensor known in the art with similar capabilities.

In one embodiment, the second gear position sensor 830 may be a magnetic type sensor (e.g., a Hall effect sensor). The second driven gear 820 may comprise a magnetic material such as a permanent magnet. For instance, a fourth magnet 825 may be coupled to the second driven gear 820. As illustrated in FIG. 27, the second driven gear 820 may have a second groove 827 formed on a surface of the second driven gear 820 facing the second gear position sensor 830 so that the fourth magnet 825 can be disposed in the second groove 827 of the second driven gear 820. In another example, a magnetic gradient may be formed on a surface of the second driven gear 820 and defined by a plurality of alternating north and south magnetically charged elements circumferentially spaced about the circumference of the second driven gear 820. The magnet field between the magnetic material of the second driven gear 820 and the second gear position sensor 830 can be varied as a function of the angular displacement of the second driven gear 820. The second gear position sensor 830 may sense or detect the magnetic field around the second driven gear 820 to identify an angular position of the second driven gear 820.

In another embodiment, the second gear position sensor 830 may be an inductive type sensor. The inductive type sensor may be a sensor configured to operate based on the principle of electromagnetic induction to detect or measure nearby metallic objects. An inductor develops a magnetic field when an electric current flows through it. Alternatively, a current will flow through a circuit containing an inductor when the magnetic field through it changes. This effect can be used to detect metallic objects that interact with a magnetic field. For example, the inductive type sensor according to an embodiment of the present disclosure may utilize aspects described in U.S. patent application Ser. No. 18/930,897, entitled “INDUCTIVE SENSOR SYSTEM COMPRISING INDUCTIVE TORQUE AND POSITION SENSOR ASSEMBLIES”, filed on Oct. 29, 2024, which is hereby incorporated herein by reference in its entirety. In an embodiment for the inductive type sensor, an excitation or transmitter coil set configured to generate an electromagnetic field over the second driven gear 820 and a receiver coil set configured to detect the electromagnetic field around the second driven gear 820 may be included in or mounted to the second circuit board 420, and metallic material such as a target having a metallic pattern or one or more conductive loops configured to affect the electromagnetic field generated by the excitation or transmitter coil set may be included in or attached to the second driven gear 820 instead of the fourth magnet 825. The inductive type sensor may reduce the size of the second powerpack 400 and lower manufacturing cost of the steer-by-wire system 10.

A processor included in at least one of the controller 50, the first circuit 320, the second circuit 420, or an electronic control unit of the vehicle 1 may receive the angular position of the first driven gear 720 and the angular position of the second driven gear 820 from the first gear position sensor 730 and the second gear position sensor 830. The processor may receive the angular position of the first driven gear 720 detected by the first gear position sensor 730 and the angular position of the second driven gear 820 detected by the second gear position sensor 830 through inter-package communication or controller area network (CAN). The processor may identify a linear position of the steering rack 36 based on the angular position of the first driven gear 720 detected by the first gear position sensor 730 and the angular position of the second driven gear 820 detected by the second gear position sensor 830. For instance, a Vernier algorithm may be used to determine the linear position of the steering rack 36 based on the angular position of the first driven gear 720 and the second driven gear 820. A gear ratio between the first driven gear 720 and the first drive gear 710 and another gear ratio between the second driven gear 820 and the second drive gear 810 are different from each other. For example, the gear ratio between the first driven gear 720 and the first drive gear 710 is 16:36, and the gear ratio between the second driven gear 820 and the second drive gear 810 is 16:37. However, if a gear ratio between the first driven gear 720 and the first drive gear 710 and another gear ratio between the second driven gear 820 and the second drive gear 810 are different from each other, any gear ratio can be used for the first drive gear 710, the first driven gear 720, the second drive gear 810, and the second driven gear 820 if appropriate or necessary. The Vernier algorithm can calculate a value by using two related variables with different phases or cycles. Due to the different gear ratios associated with the first driven gear 720 and the second driven gear 820, the processor can identify the linear position of the steering rack 36 by using the phase difference of the angular position of the first driven gear 720 detected by the first gear position sensor 730 and the angular position of the second driven gear 820 detected by the second gear position sensor 830 with different cycles. By using the Vernier algorithm based on the different rotation cycles of the first driven gear 720 and the second driven gear 820 caused by difference between one gear ratio between the first driven gear 720 and the first drive gear 710 and another gear ratio between the second driven gear 820 and the second drive gear 810, the position of the steering rack 36 may be determined without a learning algorithm, an electronics turn counter, or a linear position sensor for detecting the linear position of the steering rack 36. This is possible because both the first powerpack 300 and the second powerpack 400 are kept in synchronized with the motion of the steering rack 36 through the common driven pulley 520 operable connected with both the first drive belt 370 of the first powerpack 300 and the second drive belt 470 of the second powerpack 400, and the first drive belt 370 and the second drive belt 470 are operably connected to the first motor shaft 311 and the second motor shaft 411 which rotate the first driven gear 710 and the second driven gear 810, respectively.

Compared to an embodiment that adjusts the rotation ratios associated with the first motor 310 and the second motor 410 through the first drive pulley 360, the second drive pulley 460, the driven pulley 520 to determine a linear position of the steering rack 36, the sizes of the first and second powerpacks 300 and 400 may be further reduced or minimized by using different gear ratios associated with the first driven gear 720 of the first powerpack 300 and the second driven gear 820 of the second powerpack 400.

One or more rack supports 550 may be configured to support the steering rack 36. The rack support 550 can limit the rotation of the steering rack 36 in order to prevent the steering rack 36 from rotating relative to a non-rotating structure, for example, but not limited to, a rack housing 560. For example, in order to prevent the rotation of the steering rack 36, the rack support 550 includes a preloaded roller or a rotatable rack shoe and the steering rack 36 has a substantially flat or slightly curved surface or a shape corresponding to a shape of the rack support 550 so that the steering rack 36 is slidable while unable to rotate with respect to the rack housing 560. The cross-section of a part of the steering rack 36 may be substantially D shaped and have a flat surface or a slightly curved surface to be operably associated with the rack support 550. Alternatively, the steering rack 36 has a groove (or a protrusion) which is keyed to a protrusion (or a groove) of the rack support 550 to restrict the rotary movement of the steering rack 36.

The rack support 550 may limit the linearly movable range of the steering rack 36. The rack support 550 may provide stop positions which limit the travel of the steering rack 36 (e.g. a linearly movable range of the steering rack 36) and, thus, limits the linear movement of the steering rack 36, thereby preventing the steering rack 36 from exceeding linear movement limits.

For instance, one rack support 550 may be disposed on one side of the rack housing 560 and another rack support 550 may be disposed on another side of the rack housing 560.

The first housing part 380 has an inner space for accommodating the first drive pulley 360, the first drive belt 370, and one portion of the driven pulley 520 of the rotary-to-linear conversion mechanism 500. The second housing part 480 has an inner space for accommodating the second drive pulley 460, the second drive belt 470, and the other portion of the driven pulley 520 of the rotary-to-linear conversion mechanism 500. The first housing part 380 and the second housing part 480 may be formed as separate pieces and coupled to each other.

The first housing part 380 and the second housing part 480 are matted to one another at the center portion of the rack housing 560. The first motor shaft 311 of the first motor 310 of the first powerpack 300 and the second motor shaft 411 of the second motor 410 of the second powerpack 400 may be arranged to be coaxial to each other. The first drive belt 370 and the second drive belt 470 are arranged in parallel with each other and coupled to one common driven pulley 520 of the rotary-to-linear conversion mechanism 500.

These configurations of the first housing part 370 and the second housing part 380 may reduce component complexity and make assembly and production of the steer-by-wire system 10 easier.

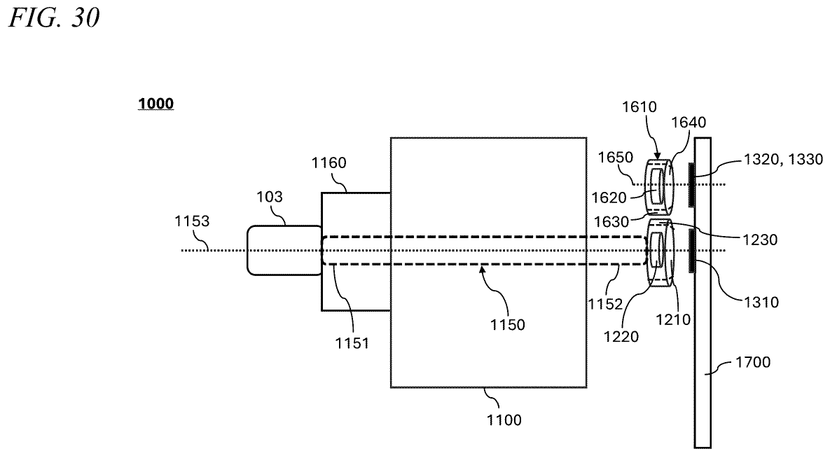

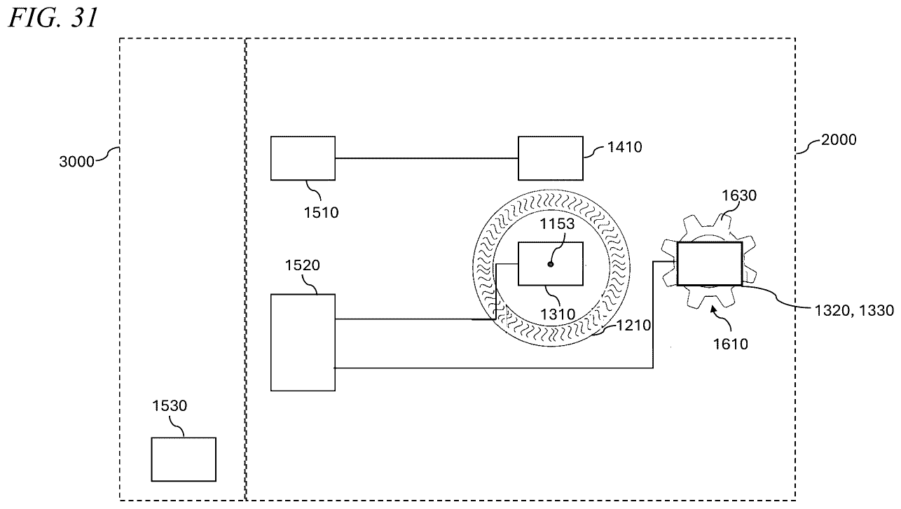

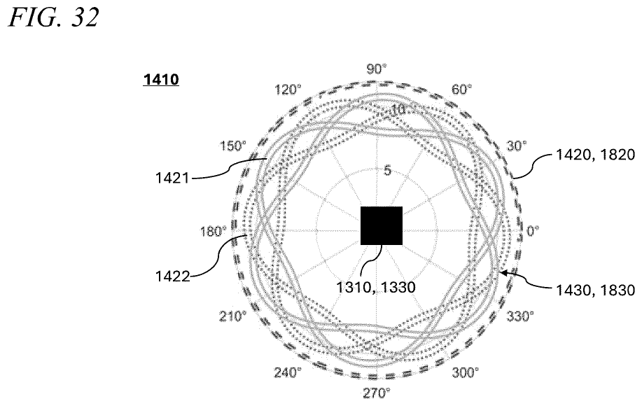

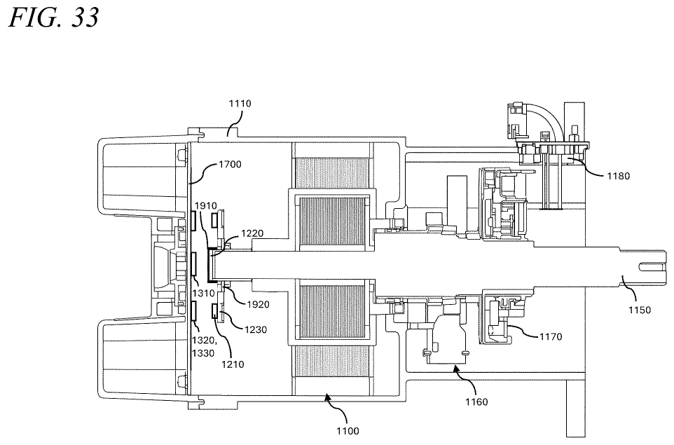

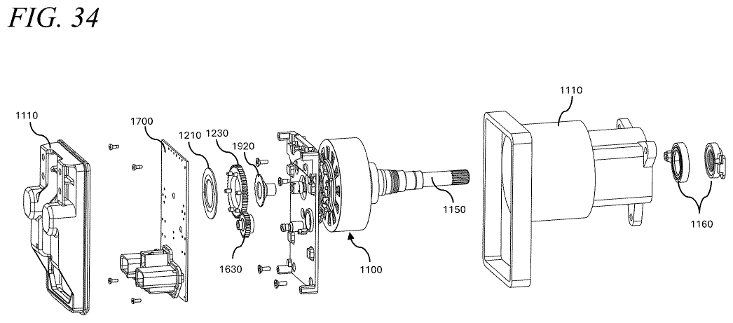

FIG. 30 is a side view for illustrating a motor system according to an embodiment of the present disclosure, FIG. 31 is a plan view for illustrating a motor system according to an embodiment of the present disclosure, FIG. 32 is a plan view for illustrating an inductive sensor according to an embodiment of the present disclosure, FIG. 33 is a cross-sectional view for illustrating a motor system according to an embodiment of the present disclosure, and FIG. 34 is an exploded view for illustrating a motor system according to an embodiment of the present disclosure.

A motor system 1000 comprises a motor 1100 having a motor shaft 1150. For example, the motor 1100 may be the motor 120 of FIG. 1 included in a steering feedback actuator assembly 2000 connected to the steering wheel 101. One end portion 1151 of the motor shaft 1150 may be directly or indirectly connected to the steering column or steering shaft 103. Alternatively, the motor 1100 may be the motor 145 or 147 of FIG. 1 or 310 or 320 of FIG. 23 included in a roadwheel actuator assembly 3000 connected to the road wheels 131. Therefore, the motor system 1000 according to an embodiment of the present disclosure may be used in both the steering feedback actuator assembly 2000 and the road wheel actuator 3000.

The motor system 1000 may further include a stopper 1160 configured to limit a rotatable range of the motor shaft 1150. The stopper 1160 provides mechanical hard stop and sets the physical limits of rotation of the steering column or steering shaft 103, ensuring that the steering wheel 101 cannot rotate beyond a predetermined range in order to prevent excessive rotation that could confuse or disorient the driver and software or sensor errors from causing unlimited spinning.

Both an inductive-sensing target 1210 and a magnet 1220 are mounted to the other end portion 1152 of the motor shaft 1150 which is positioned opposite to the one end portion 1151 to which the steering column or steering shaft 103 may be directly or indirectly coupled.

The inductive-sensing target 1210 may be included in or attached to the motor shaft 1150 or a motor gear 1230 (i.e., mounted to the motor shaft 1150). The inductive-sensing target 1210 may be an electrically conductive coupler. The inductive-sensing target 1210 may be placed in proximity to an inductive sensor 1410, for example, but not limited to, one or more receiver coils 1430 and/or one or more excitation or transmitter coils 1420. The inductive-sensing target 1210 may have a metallic pattern. For instance, the inductive-sensing target 1210 may have a multi lobe shape having the plurality of circumferentially adjacent lobes, a closed conductive loop or multiple conductive loops, or a partial circle or polygon shape such as a half circle or a half polygon. The inductive-sensing target 1210 can be configured to affect the electromagnetic field generated by one or more excitation or transmitter coils 1420.

The inductive sensor 1410 may be supported on a circuit board 1700. The inductive sensor 1410 may be disposed in sensing relationship with the inductive-sensing target 1210 mounted to the motor shaft 1150. For example, one or more receiver coils 1420 and/or one or more excitation or transmitter coils 1430 of the inductive sensor 1410 may be positioned adjacent to the inductive-sensing target 1210 mounted to the motor shaft 1150.

As shown in FIG. 32, the inductive sensor 1410 may include one or more receiver coils 1430 and/or one or more excitation or transmitter coils 1420. One or more receiver coils 1420 and/or one or more excitation or transmitter coils 1430 may be formed by conductive traces or electrically conductive pathways on the circuit board 1700 or in one of multiple layers of the circuit board 1700. The transmitter coil 1430 generates an electromagnetic field over the inductive-sensing target 1210 by a radio-frequency signal generated by an oscillator. The receiver coil 1420 may be configured to generate a signal (e.g. voltage or current) indicative of an angular position of the motor shaft 1150 in response to induction by the electromagnetic fields generated by the transmitter coil 1420 and altered by the inductive-sensing target 1210. For instance, the receiver coils 1420 may include one or more sinusoidal coils 1421 and one or more cosinusoidal coils 1422.

The receiver coil 1420 is electrically connected to a first electronic control unit (ECU) 1510 to output the signal (e.g. voltage or current) indicative of an angular position of the motor shaft 1150 to the first ECU 1510. The first ECU 1510 may comprise any suitable circuitry and electronic components, such as a microprocessor, a processor, a computer, and/or memory. The first ECU 150 is configured to determine a position of the motor shaft 1150 based on the electromagnetic induction associated with the inductive-sensing target 1210 using the signal output from the receiver coil 1420 of the inductive sensor 1410. The first ECU 150 may be an electronic control unit for a steering feedback actuator 2000.

A magnetic sensor 1310 may be supported on the circuit board 1700. The magnetic sensor 1310 may be disposed in sensing relationship with the magnet 1220 are mounted to the motor shaft 1150. The magnet 1220 of the motor shaft 1150 may be placed in proximity to the magnetic sensor 1310. For example, the magnet 1220 mounted to the motor shaft 1150 may be a puck magnet, or magnetic gradient formed on a surface of the motor shaft 1150 and defined by a plurality of alternating north and south magnetically charged elements circumferentially spaced about the circumference of the motor shaft 1150, and the magnetic sensor 1310 may be a Hall effect sensor. The magnetic field between the magnet 1220 of the motor shaft 1150 and the magnetic sensor 1310 can be varied as a function of the angular displacement of the motor shaft 1150. The magnetic sensor 1310 may sense or detect the magnetic field around the motor shaft 1150 to identify an angular position of the motor shaft 1150.

As illustrated in FIG. 31, in order for the motor system 1000 to have heterogeneous redundancy in motor position sensing using both a magnetic sensor and an inductive sensor, while the magnetic sensor 1310 may be positioned on an axis 1153 of the motor shaft 1150, the inductive sensor 1410 may be positioned offset from the axis 1153 of the motor shaft 1150.

However, the inductive sensor 1410 or the magnetic sensor 1310 cannot provide an absolute angular rotational position of the steering column or steering shaft 103 or the steering wheel 101.

In order to determine the absolute angular rotational position of the steering column or steering shaft 103 or the steering wheel 101, the motor system 1000 according to an embodiment of the present disclosure may further include an auxiliary or satellite rotor 1610 and an auxiliary sensor 1320, 1330.

The auxiliary or satellite rotor 1610 may be rotatably engaged with the motor shaft 1150. For instance, the motor shaft 1150 comprises the motor gear 1230 and the auxiliary or satellite rotor 1610 comprises an auxiliary or satellite gear 1630. The motor gear 1230 and the auxiliary or satellite gear 1630 may have gear teeth meshed with each other. The number of teeth of the motor gear 1230 is different from the number of the auxiliary or satellite gear 1630 so that the motor shaft 1150 and the auxiliary or satellite rotor 1610 can rotate at different rotational speeds in order to identify the absolute angular rotational position of the steering column or steering shaft 103 or the steering wheel 101 using the Vernier algorithm. The rotation axis 1153 of the motor shaft 1150 is parallel to and spaced apart from the rotation axis 1650 of the auxiliary or satellite rotor 1610.

In a first exemplary embodiment, a magnetic type sensing mechanism may be used for the auxiliary or satellite rotor 1610 to detect an angular position of the auxiliary or satellite rotor 1610 rotatably engaged with the motor shaft 1150. An auxiliary magnet 1620 may be included in or attached to the auxiliary or satellite rotor 1610. The auxiliary magnet 1620 of the auxiliary or satellite rotor 1610 may be a puck magnet, or magnetic gradient formed on a surface of the auxiliary or satellite rotor 1610 and defined by a plurality of alternating north and south magnetically charged elements circumferentially spaced about the circumference of the auxiliary or satellite rotor 1610. An auxiliary magnetic sensor 1320 may be supported on the circuit board 1700. The auxiliary magnetic sensor 1320 may be disposed in sensing relationship with the auxiliary magnet 1620 of the auxiliary or satellite rotor 1610. The auxiliary magnet 1620 of the auxiliary or satellite rotor 1610 may be placed in proximity to the auxiliary magnetic sensor 1320. For instance, the auxiliary magnetic sensor 1320 may be a Hall effect sensor. The magnet field between the auxiliary magnet 1620 of the auxiliary or satellite rotor 1610 and the auxiliary magnetic sensor 1320 can be varied as a function of the angular displacement of the auxiliary or satellite rotor 1610. The auxiliary magnetic sensor 1320 may sense or detect the magnetic field around the auxiliary or satellite rotor 1610 to identify an angular position of the auxiliary or satellite rotor 1610.

The auxiliary magnetic sensor 1320 is electrically connected to a second electronic control unit (ECU) 1520 for the steering feedback actuator assembly 2000 and a third electronic control unit (ECU) 1530 for the roadwheel actuator assembly 3000 to output the signal (e.g. voltage or current) indicative of the angular position of the auxiliary or satellite rotor 1610 to the second and third ECUs 1520 and 1530. Each of the second ECU 1520 and the third ECU 1520 may comprise any suitable circuitry and electronic components, such as a microprocessor, a processor, a computer, and/or memory.

In a second exemplary embodiment, an inductive type sensing mechanism may be used for the auxiliary or satellite rotor 1610 to detect an angular position of the auxiliary or satellite rotor 1610 rotatably engaged with the motor shaft 1150.

An auxiliary inductive-sensing target 1640 may be included in or attached to the auxiliary or satellite rotor 1610. The auxiliary inductive-sensing target 1640 may be an electrically conductive coupler. The auxiliary inductive-sensing target 1640 may be placed in proximity to an auxiliary inductive sensor 1330, for example, one or more receiver coils 1830 and/or one or more excitation or transmitter coils 1820. The auxiliary inductive-sensing target 1640 may have a metallic pattern. For example, the auxiliary inductive-sensing target 1640 may have a multi lobe shape having the plurality of circumferentially adjacent lobes, a closed conductive loop or multiple conductive loops, or a partial circle or polygon shape such as a half circle or a half polygon. The auxiliary inductive-sensing target 1640 can be configured to affect the electromagnetic field generated by one or more excitation or transmitter coils 1830.

The auxiliary inductive sensor 1330 may be supported on the circuit board 1700. The auxiliary inductive sensor 1330 may be disposed in sensing relationship with the auxiliary inductive-sensing target 1640 included in or attached to the auxiliary or satellite rotor 1610. For example, one or more receiver coils 1830 and/or one or more excitation or transmitter coils 1820 of the auxiliary inductive sensor 1330 may be positioned adjacent to the auxiliary inductive-sensing target 1640 included in or attached to the auxiliary or satellite rotor 1610.

The auxiliary inductive sensor 1330 may include one or more receiver coils 1830 and/or one or more excitation or transmitter coils 1830. One or more receiver coils 1830 and/or one or more excitation or transmitter coils 1820 may be formed by conductive traces or electrically conductive pathways on the circuit board 1700 or in one of multiple layers of the circuit board 1700. The transmitter coil 1820 generates an electromagnetic field over the auxiliary inductive-sensing target 1640 by a radio-frequency signal generated by an oscillator. The receiver coil 1830 may be configured to generate a signal (e.g. voltage or current) indicative of an angular position of the auxiliary inductive-sensing target 1640 in response to induction by the electromagnetic fields generated by the transmitter coil 1820 and altered by the auxiliary inductive-sensing target 1640.

The auxiliary inductive sensor 1330 (e.g., the receiver coil 1830 of the auxiliary inductive sensor 1330) is electrically connected to the second ECU 1520 for the steering feedback actuator assembly 2000 and the third ECU 1530 for the roadwheel actuator assembly 3000 to output the signal (e.g. voltage or current) indicative of the angular position of the auxiliary or satellite rotor 1610 to the second and third ECUs 1520 and 1530.

The second ECU 1520 for the steering feedback actuator assembly 2000 and the third ECU 1530 for the roadwheel actuator assembly 3000 are configured to determine an absolute angular position of the steering column or steering shaft 103 or the steering wheel 101 based on the magnetic field associated with the magnet 1220 mounted to the motor shaft 1150 and sensed by the magnetic sensor 1310 (i.e., a signal indicative of an angular position of the motor shaft 1150) and the signal output by the auxiliary magnetic sensor 1320 or the auxiliary inductive sensor 1330 (e.g. a signal indicative of an angular position of the auxiliary or satellite rotor 1610).

For instance, the Vernier algorithm may be used to determine the absolute angular position of the steering column or steering shaft 103 or the steering wheel 101 based on the angular position of the motor shaft 1150 and the angular position of the auxiliary or satellite rotor 1610. The Vernier algorithm can calculate a value by using two related variables with different phases or cycles. Because the number of teeth of the motor gear 1230 of the motor shaft 1150 is different from the number of teeth of the auxiliary or satellite gear 1630 of the auxiliary or satellite rotor 1610, the motor shaft 1150 and the auxiliary or satellite rotor 1610 can rotate at different rotational speeds and therefore the second ECU 1520 for the steering feedback actuator assembly 2000 and the third ECU 1530 for the roadwheel actuator assembly 3000 can identify the absolute angular position of the steering column or steering shaft 103 or the steering wheel 101 by using the phase difference of the angular position of the motor shaft 1150 detected by the magnetic sensor 1310 and the angular position of the auxiliary or satellite rotor 1610 detected by the auxiliary magnetic sensor 1320 or the auxiliary inductive sensor 1330 with different cycles. By using the Vernier algorithm based on the different rotation cycles of the motor shaft 1150 and the auxiliary or satellite rotor 1610, the absolute angular position of the steering column or steering shaft 103 or the steering wheel 101 may be determined.

Optionally, the motor system 1000 may further comprise a position sensor 1170 configured to detect a rotary position, angular displacement, rotational angle, or rotational state of the motor shaft 1150. The position sensor 1170 may be disposed within the motor housing 1110 and may be disposed in sensing relationship with the motor shaft 1150 to generate one or more signals corresponding to the rotary position of the motor shaft 1150 during operation of the motor 1100. In some embodiments, the position sensor 1170 may comprise, without limitation, a Hall-effect sensor, a magnetic encoder, an optical encoder, a resolver, or any other suitable position sensing element.

A connector 1180 may electrically connect the position sensor 1170 to an external component not included within the motor housing 1110. The connector 1180 may be configured to transmit a signal output from the position sensor 1170 to the external component, such as a controller, processor, or electronic control unit (ECU). In some embodiments, the connector 1180 may be disposed on or partially through the motor housing 1110 and may include one or more terminals, pins, or conductive paths configured to interface with a wiring harness or cable.

A motor housing 1110 may accommodate the motor 1100, the motor shaft 1150, the stopper 1160, the inductive-sensing target 1210, the magnet 1220, the magnetic sensor 1310, the inductive sensor 1410, the circuit board 1700, and the auxiliary or satellite rotor 1610. In one embodiment, the auxiliary magnet 1620 and the auxiliary magnetic sensor 1320 may be disposed in the motor housing 1110. In another embodiment, the auxiliary inductive-sensing target 1640 and the auxiliary inductive sensor 1330 may be included in the motor housing 1110.

The motor shaft 1150 may comprise a magnet holder 1910. The magnet holder 1910 may have an inner space for holding the magnet 1220. The magnet 1220 may be positioned within the inner space of the magnet holder 1910 such that the magnet 1220 produces magnetic flux which flows from the magnet 1220 to the magnetic sensor 1310. For example, the magnet holder 1910 may at least substantially surround the magnet 1220. The magnet holder 1910 is made of, for example, but not limited to, non-magnetic material such as brass, aluminum, potting material, plastic, a synthetic resin material, stainless steel, copper, and the like. The magnet holder 1910 includes a fixing structure or means configured to fix the magnet 1220 to the motor shaft 1150. For instance, the fixing structure or means of the magnet holder 1910 has an opening which is inserted into the distal end of the motor shaft 1150 and a wall that contacts the motor shaft 1150 and holds the magnet holder 1910 and the motor shaft 1150 together. In the magnet holder 1910, non-magnetic material may be disposed between the motor shaft 1150 and the magnet 1220. In another example, a non-magnetic material may be part of the magnet holder 1910. Alternatively, the magnet holder 1910 may have an air gap between the motor shaft 1150 and the magnet 1220.

Instead of the structure of the magnet holder 1910 illustrated in FIG. 33, the magnet holder can be implemented as an adhesive made of non-magnetic material. Any material that can hold the magnet 1220 and the motor shaft 1150 together and reduce leakage magnetic flux from the magnet 1220 to the motor shaft 1150 can be used for the adhesive.

The motor shaft 1150 may include or be coupled to a gear and/or target holder 1920. The gear and/target holder 1920 may be configured to fix at least one of the motor gear 1230 and/or the inductive-sensing target 1210 to the motor shaft 1150 such that the motor gear 1230 and/or the inductive-sensing target 1210 rotate together with the motor shaft 1150 during operation. In one embodiment, the gear and/or target holder 1920 may fixedly couple the motor gear 1230 to the motor shaft 1150, and the inductive-sensing target 1210 may be attached to, integrated with, or mounted on the motor gear 1230. In another embodiment, the gear and/or target holder 1920 may hold one of the motor gear 1230 and the inductive-sensing target 1210 to be fixed to the motor shaft 1150, while the other of the motor gear 1230 and the inductive-sensing target 1210 may be directly coupled to the motor shaft 1150. For example, the motor gear 1230 may be directly coupled to the motor shaft 1150, while the inductive-sensing target 1210 is fixed to the motor shaft 1150 via the gear and/or target holder 1920, or vice versa. In still another embodiment, the gear and/target holder 1920 may have separate structures, portions, or coupling features configured to respectively couple the motor gear 1230 and the inductive-sensing target 1210 to the motor shaft 1150. In such an embodiment, the motor gear 1230 and the inductive-sensing target 1210 may be independently mounted while remaining rotationally synchronized with the motor shaft 1150.

Alternatively, in some embodiments, either one or both of the motor gear 1230 and the inductive-sensing target 1210 may be directly coupled to the motor shaft 1150 without the gear and/or target holder 1920. Such direct coupling may be achieved by press-fitting, splining, keying, interference fitting, adhesive bonding, integral formation, or any other suitable mechanical coupling technique.

Although the example embodiments have been described in detail, it should be understood that various changes, substitutions and alterations can be made herein without departing from the spirit and scope of the application as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

What is claimed is:

1. A motor system comprising:
an inductive-sensing target and a magnet which are mounted to a motor shaft;
a circuit board;
a magnetic sensor configured to sense magnetic field associated with the magnet mounted to the motor shaft; and
an inductive sensor configured to sense electromagnetic induction associated with the inductive-sensing target mounted to the motor shaft,
wherein the magnetic sensor and the inductive sensor are mounted to the circuit board.

2. The motor system of claim 1, wherein the magnetic sensor and the inductive sensor are mounted to a surface of the circuit board facing an end of the motor shaft to which the inductive-sensing target and the magnet are mounted.

3. The motor system of claim 1, further comprising a magnet holder coupling the magnet to the motor shaft.

4. The motor system of claim 1, wherein the magnet mounted to the motor shaft is disposed within an inner space of the magnet holder.

5. The motor system of claim 1, wherein the magnet holder has non-magnetic material.

6. The motor system of claim 1, further comprising a controller configured to determine a position of the motor shaft based on at least one of the magnetic field associated with the magnet mounted to the motor shaft or the electromagnetic induction associated with the inductive-sensing target mounted to the motor shaft.

7. The motor system of claim 1, wherein the inductive sensor is positioned offset from an axis of the motor shaft, and the magnetic sensor is disposed on the axis of the motor shaft.

8. The motor system of claim 1, further comprising an auxiliary rotor rotatably engaged with the motor shaft.

9. The motor system of claim 8, wherein each of the motor shaft and the auxiliary rotor comprises a gear, the gear of the motor shaft and the gear of the auxiliary rotor are rotatably engaged with one another, and a number of teeth of the gear of the motor shaft is different from a number of the gear of the auxiliary rotor.

10. The motor system of claim 9, further comprising a gear holder coupling the gear to the motor shaft.

11. The motor system of claim 10, wherein the inductive-sensing target is coupled to the gear of the motor shaft.

12. The motor system of claim 8, wherein an other magnet is mounted to the auxiliary rotor, and the motor system further comprises an other magnetic sensor configured to sense magnetic field associated with the other magnet mounted to the auxiliary rotor.

13. The motor system of claim 8, wherein the auxiliary rotor includes an other inductive-sensing target, and the motor system further comprises an other inductive sensor configured to sense electromagnetic induction associated with the other inductive-sensing target included in the auxiliary rotor.

14. The motor system of claim 1, wherein the motor shaft is connected to a steering column connected to a steering wheel.

15. The motor system of claim 1, wherein one end portion of the motor shaft is connected to a steering column connected to a steering wheel, and the inductive-sensing target and the magnet are mounted to an other end portion of the motor shaft.

16. The motor system of claim 1, further comprising:
an auxiliary rotor rotatably engaged with the motor shaft, and having an other magnet; and
an other magnetic sensor configured to sense magnetic field associated with the other magnet mounted to the auxiliary rotor,
wherein:
the motor shaft is connected to a steering column connected to a steering wheel, and
the controller is configured to determine a position of the steering column or the steering wheel based on the magnetic field associated with the other magnet mounted to the auxiliary rotor and at least one of the magnetic field associated with the magnet mounted to the motor shaft or the electromagnetic induction associated with the inductive-sensing target mounted to the motor shaft.

17. The motor system of claim 1, further comprising:
an auxiliary rotor rotatably engaged with the shaft of the motor, and comprising an other inductive-sensing target; and
an other inductive sensor configured to sense electromagnetic induction associated with the other inductive-sensing target comprised in the auxiliary rotor,
wherein:
the motor shaft is connected to a steering column connected to a steering wheel, and
the controller is configured to determine a position of the steering column or the steering wheel based on the electromagnetic induction associated with the other inductive-sensing target comprised in the auxiliary rotor and at least one of the magnetic field associated with the magnet mounted to the motor shaft or the electromagnetic induction associated with the inductive-sensing target mounted to the motor shaft.

18. The motor system of claim 1, further comprising a stopper configured to limit a rotatable range of the motor shaft.

19. The motor system of claim 1, wherein:
the inductive-sensing target has a metallic pattern, and
the inductive sensor comprises a receiver including a sinusoidal coil and a cosinusoidal coil and a transmitter including at least one circular coil.

20. A steer-by-wire system comprising:
a steering feedback actuator assembly connected to a steering wheel; and
a roadwheel actuator assembly connected to road wheels,
wherein the steering feedback actuator assembly includes a motor system comprising:
a motor having a motor shaft connected to a steering column connected to the steering wheel;
a circuit board;
an inductive-sensing target and a magnet which are mounted to the motor shaft;
a magnetic sensor configured to sense magnetic field associated with the magnet mounted to the motor shaft; and
an inductive sensor configured to sense electromagnetic induction associated with the inductive-sensing target mounted to the motor shaft.
